(19) United States
(12) Patent Application Publication
(10) Pub. No.: US 2026/0129578 A1
(43) Pub. Date: May 7, 2026

(54) BACKSCATTER COMMUNICATIONS IN A MULTI-STATIC SCENARIO

(71) Applicant: QUALCOMM Incorporated, San Diego, CA (US)

(72) Inventors: Piyush GUPTA, Bridgewater, NJ (US); Raviteja PATCHAVA, San Diego, CA (US); Le LIU, San Jose, CA (US); Yuchul KIM, San Diego, CA (US)

(21) Appl. No.: 19/332,800

(22) Filed: Sep. 18, 2025

Related U.S. Application Data
(60) Provisional application No. 63/715,953, filed on Nov. 4, 2024.

(51) Int. Cl. H04W 52/02; H04W 52/24

(52) U.S. Cl. CPC H04W 52/0229; H04W 52/242

(57) ABSTRACT

Certain aspects of the present disclosure provide techniques for backscatter communications. An example method includes sending, to a first set of backscatter devices, one or more first signals via a first transmit beam at a first transmit power in one or more first transmission occasions; and sending, to a second set of backscatter devices, one or more second signals via a second transmit beam at a second transmit power in one or more second transmission occasions.

### CROSS-REFERENCE TO RELATED APPLICATION(S)

The present application for Patent claims benefit of and priority to U.S. Provisional Application No. 63/715,953, filed Nov. 4, 2024, which is herein incorporated by reference in its entirety.

### INTRODUCTION

### Field of the Disclosure

Aspects of the present disclosure relate to wireless communications, and more particularly, to techniques for backscatter communications in a multi-static scenario.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a first device. The method includes sending, to a first set of backscatter devices, one or more first signals via a first transmit beam at a first transmit power in one or more first transmission occasions; and sending, to a second set of backscatter devices, one or more second signals via a second transmit beam at a second transmit power in one or more second transmission occasions.

Certain aspects provide a method for wireless communications by a first device. The method includes obtaining, from a first set of backscatter devices, one or more first signals via a first receive beam within a first set of received signal powers in one or more first transmission occasions; and obtaining, from a second set of backscatter devices, one or more second signals via a second receive beam within a second set of received signal powers in one or more second transmission occasions.

Certain aspects provide a method for wireless communications by a first device. The method includes sending, to a first set of backscatter devices, a first signal via a first beam at a first transmit power in one or more first transmission occasions; obtaining, from the first set of backscatter devices, a first set of signals via the first beam within a first set of received signal powers in one or more second transmission occasions; sending, to a second set of backscatter devices, a second signal via a second beam at a second transmit power in one or more third transmission occasions; and obtaining, from the second set of backscatter devices, a second set of signals via the second beam within a second set of received signal powers in one or more fourth transmission occasions.

Certain aspects provide a method for wireless communications by a first device. The method includes sending, to a first set of backscatter devices, one or more first energy excitation signals at a first transmit power in one or more first transmission occasions; and sending, to a second set of backscatter devices, one or more second energy excitation signals at a second transmit power in one or more second transmission occasions.

Certain aspects provide a method for wireless communications by a backscatter device. The method includes obtaining a first signal, associated with a first sector, in one or more first transmission occasions; sending a second signal in one or more second transmission occasions; obtaining an indication to ignore signaling associated with a second sector for a time period; obtaining a third signal associated with the second sector during the time period; and refraining from sending a reply associated with the third signal.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts example components of an energy harvesting-capable Internet-of-Things (IoT) device.

FIG. 6 depicts aspects relating to different RF energy harvesting and RF communication architectures for an energy harvesting-capable device.

FIG. 7A depicts an example monostatic system.

FIG. 7B depicts an example multi-static system.

FIG. 7C depicts another example multi-static system.

FIG. 8A depicts a process flow diagram of an example inventory procedure.

FIG. 8B depicts a process flow diagram of an example two-step inventory procedure.

FIGS. 9A and 9B depict example schemes for backscatter communications in a multi-static scenario, for example, with respect to FIG. 7C.

FIGS. 10A and 10B depict example schemes for backscatter communications in a multi-static scenario, for example, with respect to FIG. 7B.

FIG. 11A depicts a process flow for backscatter communications.

FIG. 11B depicts another process flow for backscatter communications.

FIG. 12 depicts a method for wireless communications.

FIG. 13 depicts another method for wireless communications.

FIG. 14 depicts another method for wireless communications.

FIG. 15 depicts another method for wireless communications.

FIG. 16 depicts another method for wireless communications.

FIG. 17 depicts aspects of an example communications device.

FIG. 18 depicts aspects of an example communications device.

### DETAILED DESCRIPTION

Aspects of the present disclosure provide apparatuses, methods, processing systems, and computer-readable mediums for backscatter communications in multi-static scenario(s).

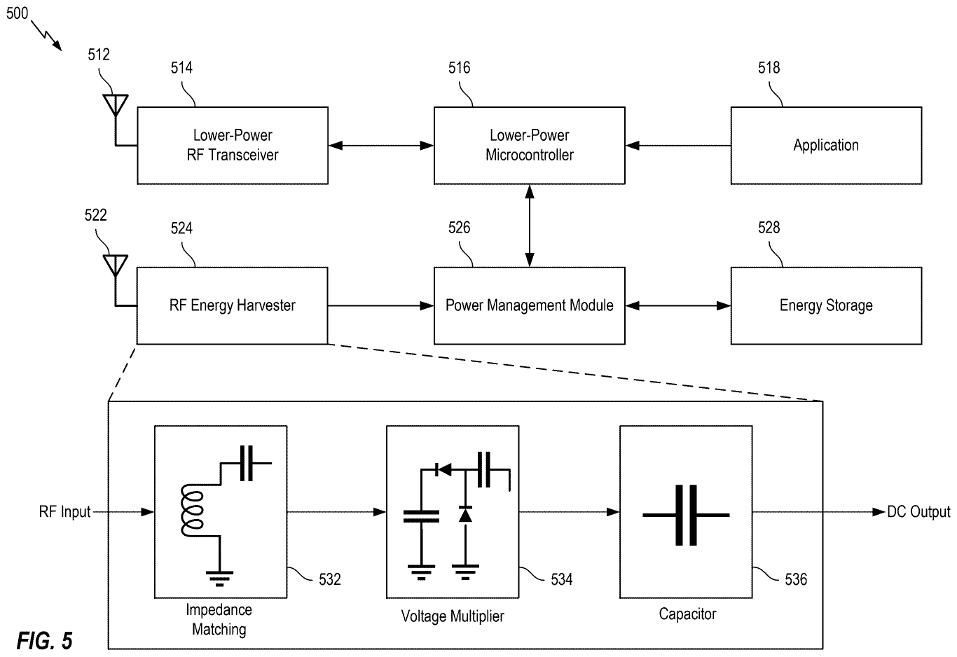

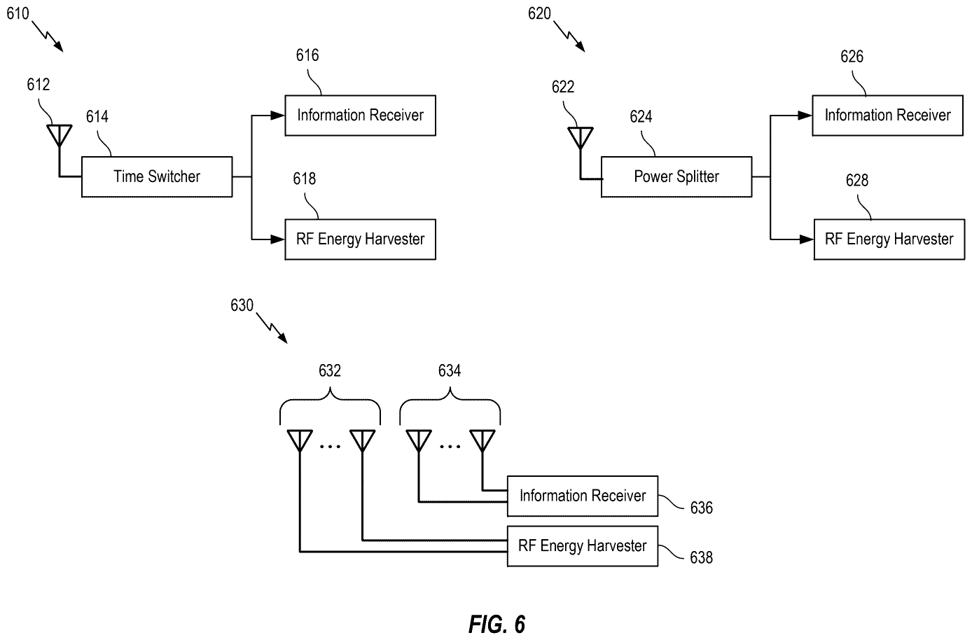

Certain wireless communications systems (e.g., an Evolved Universal Terrestrial Radio Access (E-UTRA) system, 5G New Radio (NR) system, and/or any future wireless communication system) may enable access to network services using a physical layer configured for very low power consumption and low complexity, which may be beneficial for certain devices operating on battery power and/or utilizing power harvesting circuitry, such as Internet-of-Things (IoT) devices. IoT devices may include, for example, tags, sensors, actuators, and/or wearables, such as asset tracking, smart watches, rings, and/or health or medical monitoring devices. A class of IoT devices may include ambient IoT devices, which may have ultra-low complexity, ultra-low power consumption, a small form factor (e.g., a thickness of about 1 millimeter), and/or a long life cycle. In certain cases, an ambient IoT device may be battery-less and/or have relatively small energy storage capacity (e.g., a capacitor or small battery). Ambient IoT devices may include active IoT devices, semi-passive IoT devices, and/or passive IoT devices, as further described herein with respect to FIGS. 5 and 6. An ambient IoT device may be a self-powered device that is capable of active transmission and/or passive backscattering of radio frequency (RF) signals, for example, through energy harvesting, in order to prolong the operational life of the device and enable minimal or no human intervention.

Technical problems for ambient IoT communications may include, for example, effective mitigation of near-far effects of backscatter communications. In certain cases, an ambient IoT device may communicate by backscattering RF signals received from an energy exciter. Note that terms “energy exciter,” “energy source,” “energizer,” “illuminator,” “activator,” or the like may be used interchangeably. As an example, the energy exciter may transmit an energy excitation signal, such as an RF signal having a continuous waveform (e.g., a sinusoidal waveform). The ambient IoT device may receive the RF signal from the energy exciter, modulate information on the received signal, and reflect the modulated RF signal to a reader. Such a process may be referred to as backscattering or backscatter communications. A backscatter device may refer to a device that is capable of backscatter communications. A backscatter device may be or include a semi-passive IoT device, and/or a passive IoT device. As used herein, a reader may refer to a wireless communications device that is capable of wirelessly communicating with an IoT device, such as an ambient IoT device. As an example, the reader may be or include a user equipment (UE), a network node (e.g., a base station, access point, and/or a disaggregated entity thereof), or any suitable wireless communications device. Further, it should be understood that, unless otherwise specifically stated, terms such as “reader,” “radio frequency identification (RFID) reader,” “tag reader,” and the like are intended to be interchangeable.

In certain cases, the reader may encounter near-far effects associated with backscatter communications. In addition, the backscatter communications may use certain multiplexing techniques (such as code division multiplexing (CDM) and/or frequency division multiplexing (FDM)), which may be sensitive to near-far effects. As an example, the reader may send a broadcast message (e.g., a query or command) to backscatter devices arranged at various locations relative to the reader. The backscatter devices may send a reply at different transmit powers (e.g., due to the varying path losses between the respective backscatter device and the reader), and the reader may receive the replies at varying received signal powers. As an example, the reader may receive the reply from a first backscatter device arranged close to the reader with a strong received signal power (due to a small path loss), and the reader may receive the reply from a second backscatter device arranged far from the reader with a weak received signal power (due to a large path loss). Thus, the varying received signal powers associated with the near-far effects may impact the reader's ability to detect and/or decode weak received signals among strong received signals.

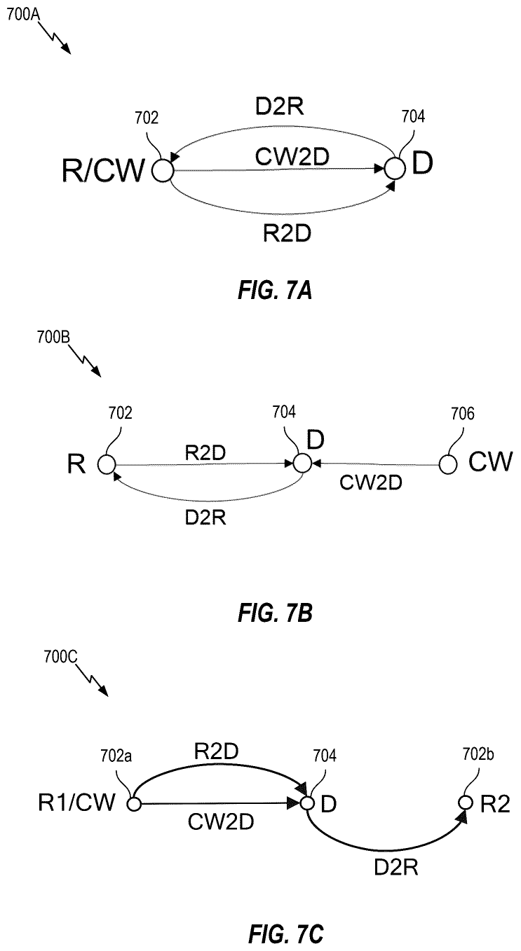

In certain cases, backscatter communications may employ monostatic and/or multi-static (e.g., bi-static) topologies, for example, as further described herein with respect to FIGS. 7A-7C. A monostatic scenario may refer to a system topology or configuration where the reader and the energy exciter are collocated or integrated as the same device, for example, as further described herein with respect to FIG. 7A. A multi-static scenario (e.g., a bi-static scenario) may refer to a system topology or configuration where the transmitter and receiver associated with a reader are separate devices and/or where a reader and energy exciter are separate devices. As used herein, “multi” in the term “multi-static” may refer to “two or more” or “more than one.” Thus, a multi-static scenario may include a plurality of network nodes including a plurality of readers and/or a set of network nodes including a reader and an energy exciter. As an example, a bi-static scenario (which may be an example of a multi-static scenario) may refer to a scenario where the energy exciter and the reader are separate devices, for example, as further described herein with respect to FIG. 7B. Another example multi-static scenario may include a scenario where the reader is disaggregated into a transmitter and a receiver that are not collocated with each other, for example, as further described herein with respect to FIG. 7C. Accordingly, the near-far effect may impact the performance of wireless communications between a reader and backscatter devices in a multi-static scenario, for example, in terms of latencies, reliability, and/or channel usage.

Aspects described herein may overcome the aforementioned technical problem(s), for example, by providing certain scheme(s) for backscatter communications that may mitigate or avoid the near-far effects encountered at a reader in certain multi-static scenarios. In certain aspects, a reader may communicate with backscatter devices by sweeping through certain beamformed sectors (or regions) or segments thereof at different transmission occasions. The beamformed sectors may enable the reader to effectively communicate with a specific group of backscatter devices with similar path losses between the respective backscatter device and the reader. As an example, the reader may communicate with a first set of backscatter devices arranged in a first sector, and then the reader may communicate with a second set of backscatter devices arranged in a second sector. As the first set of backscatter devices may be arranged proximate to each other in the first sector, the reader may receive signals from the first set of backscatter devices within a certain range of received signal powers that may avoid the near-far effect. Thus, the reader may successfully detect and decode the signals received from the first set of backscatter devices, and likewise for the second set of backscatter devices. In a bi-static scenario where the energy exciter is not collocated with the reader, the energy exciter may be configured to sweep through certain coverage areas at different transmission occasions. As an example, the energy exciter may transmit energy excitation signals at different transmit powers to hit different sets of backscatter devices.

Certain techniques for backscatter communications described herein may provide various beneficial technical effects and/or advantages. The techniques for backscatter communications may enable improved wireless communications performance, such as increased reliability, improved channel usage, reduced latencies, and/or the like. The increased reliability, improved channel usage, and/or reduced latencies may be attributable to performing backscatter communications in a sectored fashion that may avoid and/or mitigate near-far effects, which may cause retransmissions. As discussed above, the reader may communicate with backscattered devices by sweeping through different sectors in which the backscatter devices are located. Such a process may enable the reader to communicate with backscatter devices with path losses between the reader and the respective backscatter device that may avoid the near-far effect. Accordingly, the reader may detect and decode the signals received from the backscatter devices with increased reliability, and in turn improved channel usage and/or reduced latencies.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

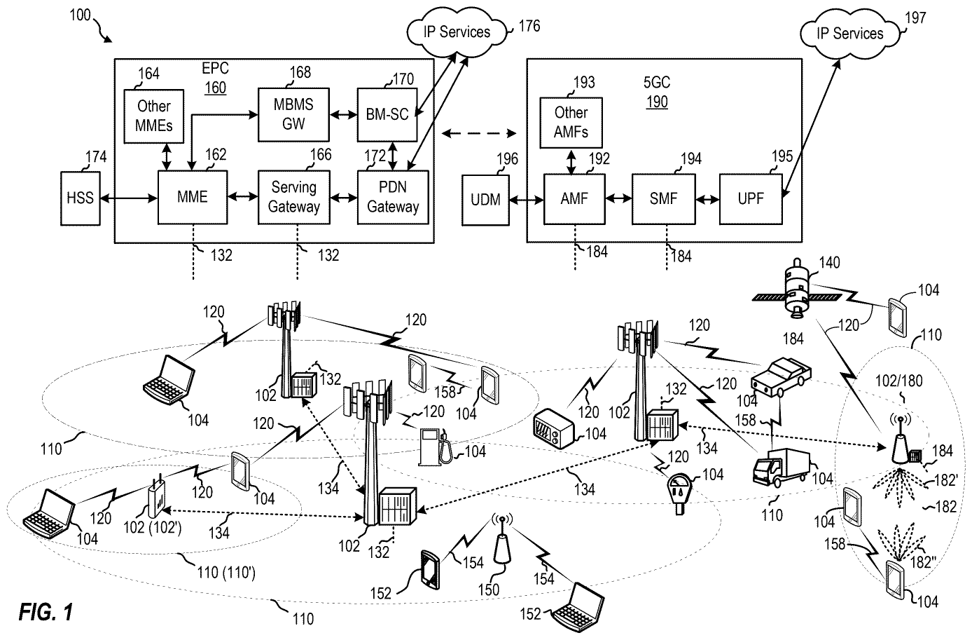

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In certain aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

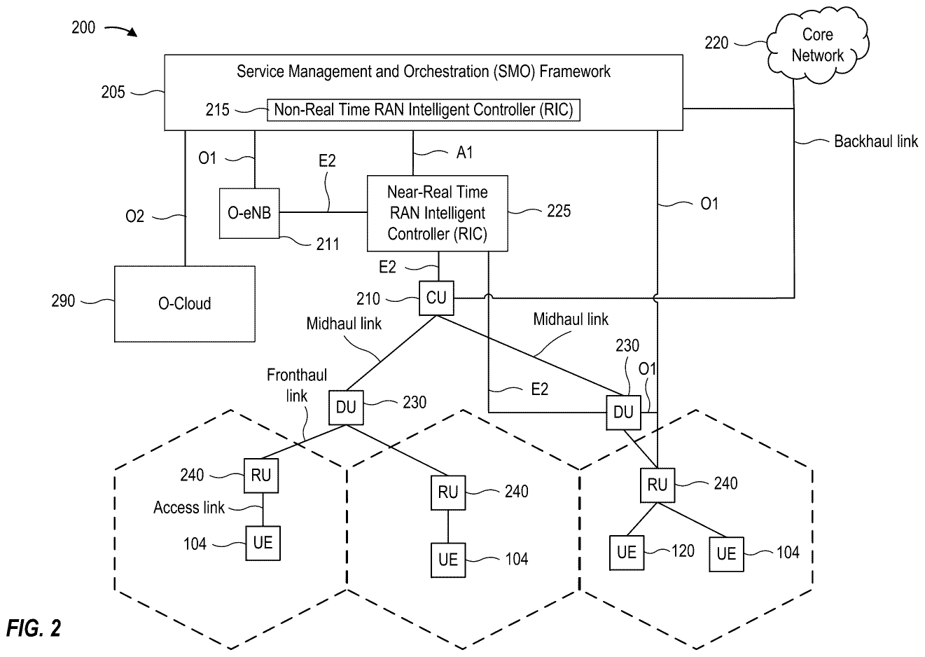

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In certain aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In certain aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In certain aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In certain aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In certain aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an 02 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

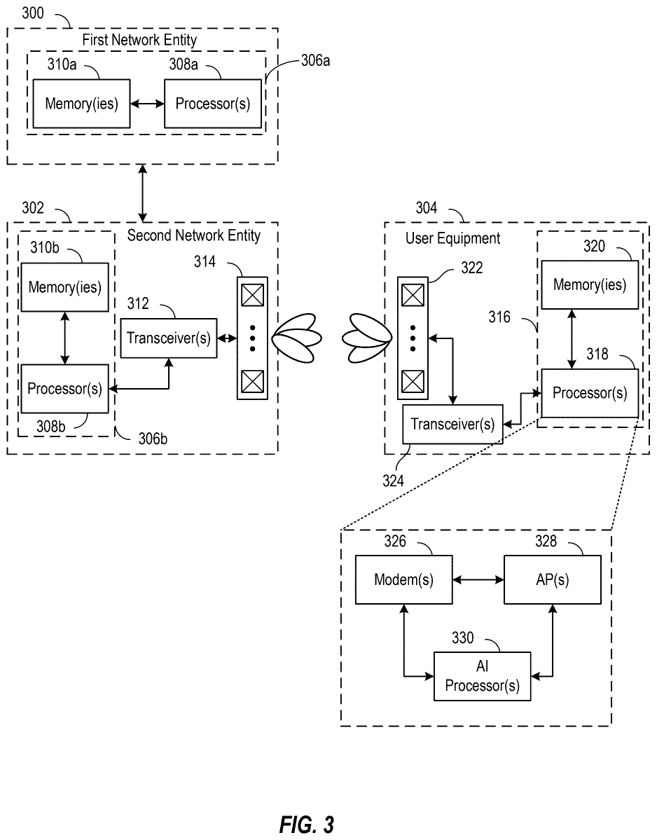

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In certain aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In certain aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

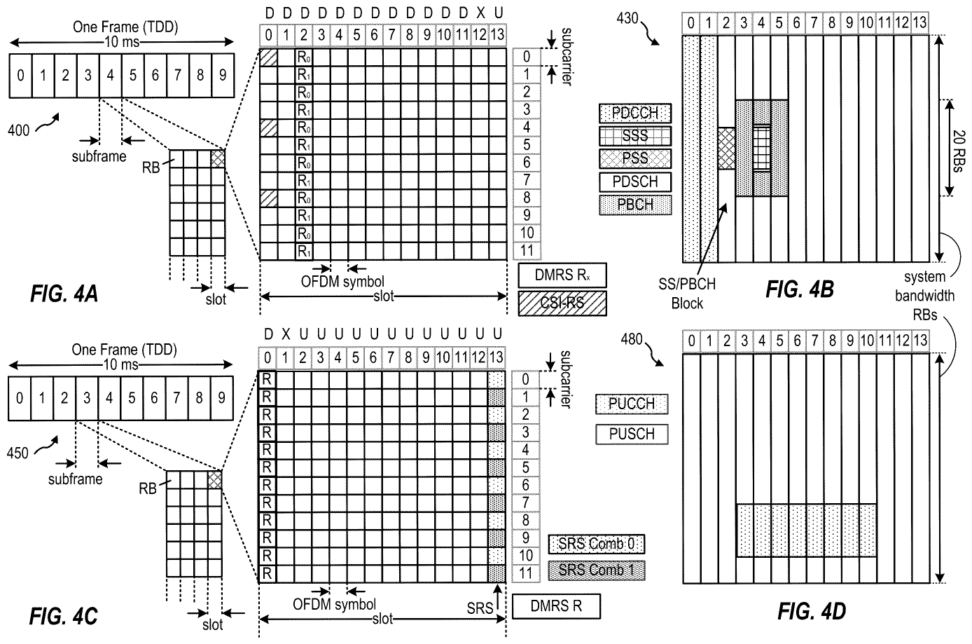

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Ambient IoT Devices

Generally, ambient IoT devices may include several device subclasses, including active IoT devices, semi-passive IoT devices, and passive IoT devices. Ambient IoT devices are generally capable of operating based on energy harvested from the ambient environment, such as from received radio frequency (RF) energy, solar energy, vibrational energy, and/or the like.

An active IoT device is generally capable of harvesting ambient energy as well as using energy stored onboard the device, such as through a battery or capacitor. An active IoT device generally includes both active radio equipment (e.g., an active radio) and passive radio equipment (e.g., a backscatter-type radio). A backscatter-type radio uses existing radio frequency signals to transmit data by modifying (e.g., modulating) and reflecting received signals with encoded data. Capabilities of an active IoT device may thus be similar to other types of UEs with the addition of energy harvesting capabilities.

A semi-passive (or semi-active) IoT device is generally capable of harvesting ambient energy as well as using energy stored onboard the device, and likewise generally includes both active radio equipment and passive radio equipment, like a backscatter-type radio. In some cases, semi-passive IoT devices may be capable of synchronous (e.g., course synchronous) and asynchronous communication. In some cases, semi-passive IoT devices may omit a power amplifier and/or a low-noise amplifier. Further, semi-passive IoT devices may generally use a reduced protocol stack (e.g., compared to an active IoT device). These aspects of semi-passive IoT device generally help to balance power consumption, functionality, and cost. So-called “ultra-light IoT” devices are one type of semi-passive IoT device.

A passive IoT device is generally capable of operating based on energy harvested from the environment using passive radio equipment (e.g., a backscatter-type radio). Passive IoT devices are generally capable of asynchronous communication and may not have a power amplifier or a low-noise amplifier. Passive IoT devices may generally use a reduced protocol stack (e.g., compared to an active IoT device).

FIG. 5 depicts example components 500 of an energy harvesting-capable IoT device (e.g., a UE). Various example components 500 may be incorporated into ambient IoT devices.

In this example, components 512-518 are aspects of a data transmission pipeline. In particular, antenna 512 and RF transceiver 514 (e.g., a low power RF transceiver) may transmit and/or receive data. Microcontroller 516 (e.g., a low power microcontroller) may process data received from an application 518.

Further in this example, components 522-528 are aspects of an RF-energy-harvesting pipeline. In particular, antenna 522 and an RF energy harvester 524 are configured to harvest RF energy. In certain aspects, RF energy harvester 524 includes an impedance matching circuit 532, a voltage multiplier 534, and a capacitor 536 to collect RF signals and convert them into electricity. In certain aspects, a power management module 526 determines whether to store the electricity obtained from the RF energy harvester 524 or to use the electricity for information transmission immediately. In this example, energy storage 528 (e.g., a battery or a capacitor) is configured to store energy converted by the RF energy harvester 524.

As above, in various aspects, an ambient IoT device may include the components depicted and described with respect to FIG. 5. In certain aspects, a passive IoT device may omit certain aspects depicted and described with respect to FIG. 5, such as energy storage 528. Further, while multiple antennas (512 and 522) are depicted in this example, in others, a single antenna and antenna switching component may be used to share the antenna between transceiver 514 and RF energy harvester 524, such as described further with respect to FIG. 6.

FIG. 6 depicts aspects 610, 620, and 630 relating to different RF energy harvesting and RF communication architectures for an energy harvesting-capable device, such as an ambient IoT device.

In particular, aspect 610 depicts antenna 612 connected to time switcher 614. In certain aspects, time switcher 614 is configured to allow an energy harvesting-capable UE to switch between (1) being connected to information receiver 616 and (2) being connected to RF energy harvester 618. For example, the device may exchange wireless communication and RF energy at different, e.g., non-overlapping, times.

Aspect 620 depicts antenna 622 connected to power splitter 624. In certain aspects, power splitter 624 is configured to allow an energy harvesting-capable device to distribute power between (1) information receiver 626 and (2) RF energy harvester 628. Thus, in this example, the device may exchange wireless communication and RF energy at overlapping times. For example, a received RF signal may be split into two streams, with one stream for the information receiver 626 and the other stream for the RF energy harvester 628.

Aspect 630 depicts an example separated receiver architecture. In particular, a first set of antennas 632 is connected with an RF energy harvester 638 and a second set of antennas 634 is connected with information receiver 636. FIG. 5, described above, depicts a separated receiver architecture.

RF energy may be harvested from various signal types. For example, RF energy may be harvested via one or more of a deterministic signal (e.g., a pilot signal), a random signal (e.g., a circularly symmetric complex Gaussian random signal), and/or an improper complex Gaussian random signal (e.g., a signal in which real and imaginary components have different variances).

### Example Ambient IoT Network Topologies

Wireless communications systems may employ various topologies to communicate with ambient IoT devices, such as backscatter devices. The topologies may include, for example, monostatic and/or multi-static (such as bi-static).

FIG. 7A depicts an example monostatic system 700A. In this example, a reader 702 may perform reader functionalities and energy excitation functionalities. The reader 702 may send an energy excitation signal to an IoT device 704, for example, via a continuous wave transmitter to device (CW2D) link. Note that the CW2D link refers to the communication link or propagation path for signaling communicated between an energy exciter (such as the reader 702) and a backscatter device (such as the IoT device 704). The reader 702 may send, to the IoT device 704, a first signal that carries information or data via a forward link (e.g., a reader to device (R2D) link). The reader 702 may obtain, from the IoT device 704, a second signal that carries information or data via a reverse or backward link (e.g., a device to reader (D2R) link). In certain cases, the IoT device 704 may send the second signal by modulating and backscattering the energy excitation signal.

FIG. 7B depicts an example multi-static system 700B. In this example, the multi-static system 700B may include a reader 702 and an energy exciter 706. The reader 702 and an energy exciter may be separate devices. The multi-static system 700B may be an example of a bi-static system. In certain cases, the energy exciter 706 may not be collocated with the reader 702. For example, the energy exciter 706 may be physically separated from the reader 702. In certain cases, the energy exciter 706 may be or include a transmitter outside of the topology of the reader 702. As an example, the energy exciter 706 may be or include an ambient energy source, such as a television tower, radio tower, WiFi access point, or the like. The energy exciter 706 may send an energy excitation to the IoT device 704 via the CW2D link. The reader 702 may communicate with the IoT device 704 via the R2D link and the D2R link as discussed herein with respect to FIG. 7A.

FIG. 7C depicts another example multi-static system 700C. In this example, a reader may be disaggregated into a transmitter and a receiver. The multi-static system 700C may be another example of a bi-static system. The multi-static system 700C may include a first reader 702a and a second reader 702b. The first reader 702a (e.g., a transmitter) may send, to the IoT device 704, a first signal that carries information or data via the R2D link, and the second reader 702b (e.g., a receiver) may obtain, from the IoT device 704, a second signal that carriers information or data via the D2D link. In certain cases, the first reader 702a may serve as an energy source for the IoT device 704. As an example, the first reader 702a may transmit the energy excitation signal to the IoT device 704 via the CW2D link. In certain cases, a separate energy source may be included in the multi-static system 700C, for example, as described herein with respect to FIG. 7B.

### Example Ambient IoT Inventory Procedure

Certain wireless communication systems (e.g., a 5G NR system and/or any future wireless communications system) may provide certain ambient IoT services, such as an inventory service or procedure. An inventory procedure may allow a reader to query an ambient IoT device for certain information including, for example, asset or device information, a device or asset identifier (e.g., an electronic produce code), a device or asset state, sensor data or measurements, and/or the like.

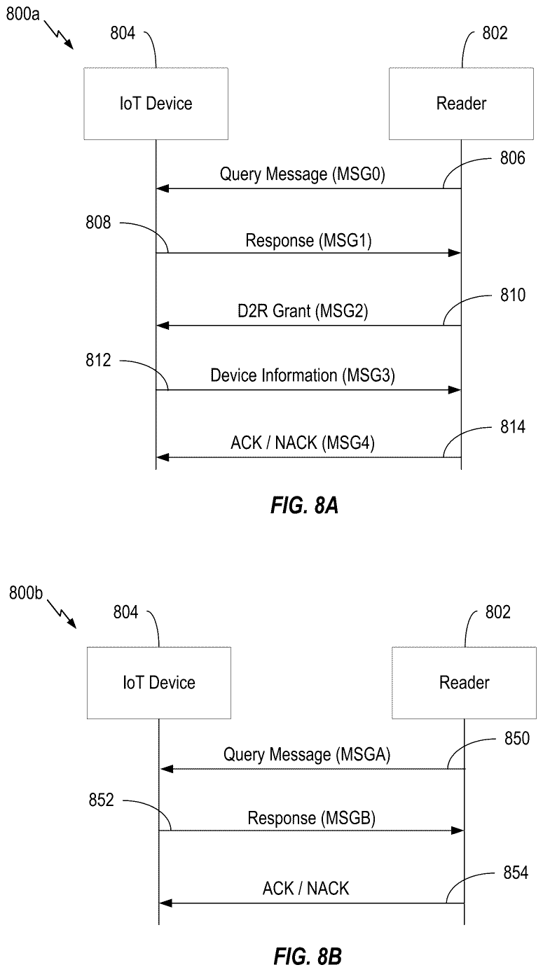

FIG. 8A depicts a process flow diagram of an example inventory procedure 800a performed between an IoT device 804 and a reader 802. In certain aspects, the IoT device 804 may be an example of the UE 104 depicted and described with respect to FIG. 1. In certain aspects, the IoT device 804 may include any of the energy harvesting architectures described herein with respect to FIGS. 5 and 6. The reader 802 may be an example of the base station 102 depicted and described with respect to FIGS. 1 and 3 or a disaggregated base station depicted and described with respect to FIG. 2. In certain aspects, the reader 802 may be an example of the UE 104 depicted and described with respect to FIGS. 1 and 3.

The inventory procedure 800a may begin at 806, where the reader 802 broadcasts and the IoT device 804 receives a query message (MSG0). The query message may request that a certain set of IoT devices respond to the query. The query message may request that the response include certain information, such as a device or asset identifier, sensor measurement(s), and/or the like. The query message may indicate communication resource(s) for communication of the response. The communication resource(s) may include a time-domain resource(s), frequency-domain resource(s), and/or sequence(s) associated with a spread-spectrum code. The communication resource(s) may be included in a pool of communication resources made available to multiple IoT devices to communicate responses in reply to the query message.

At 808, the IoT device 804 sends a response (MSG1) to the reader 802. In certain cases, the response may be communicated via a physical random access channel (PRACH) in a random access occasion (RO). In certain aspects, the response may be communicated based on time division multiplexing (TDM), frequency division multiplexing (FDM), code division multiplexing (CDM), and/or the like. For TDM, the IoT device 804 may be allocated a transmission time interval (TTI) to send the response. For FDM, the IoT device 804 may be allocated a frequency shift to modulate a received excitation signal into a specific frequency subband. For CDM, the IoT device 804 may be allocated a sequence associated with a spread-spectrum code to modulate the received excitation signal. The IoT device 804 may randomly select the TTI, frequency shift, and/or sequence among a pool of communication resources, for example, indicated by the query message.

At 810, the reader 802 may respond with a D2R grant (MSG2). For example, the reader 802 may allocate communication resources (e.g., one or more time-frequency resources) for the IoT device 804 to reply with certain information, a device or asset identifier (e.g., electronic product code), sensor measurement(s), and/or the like. The communication resources may be allocated for communications via the D2R link. In certain cases, the D2R grant may indicate one or more time-frequency resources associated with communication based at least in part on FDM, such as a frequency shift assigned to the IoT device 804. In certain cases, the D2R grant may indicate a sequence associated with communication based at least in part on CDM, such as a sequence associated with a spread-spectrum code.

At 812, in response to the D2R grant, the IoT device 804 transmits certain device information (MSG3) to the reader 802 via the D2R link. In certain aspects, MSG3 may be communicated in the time-frequency resource(s) indicated in the D2R grant.

At 814, the reader 802 may send feedback in response to MSG3. The feedback may indicate whether the reader 802 successfully received and decoded the MSG3 transmission. The feedback may include an acknowledgement (ACK) message that indicates that the reader 802 successfully received and decoded the MSG3 transmission. The feedback may include a negative acknowledgement (NACK) message that indicates that the reader 802 did not successfully receive or decode the MSG3 transmission. In certain aspects, an ACK may indicate, to the IoT device 804, to refrain from responding to subsequent query messages for a certain time period.

In some cases, to reduce the latency associated with the inventory procedure, a two-step inventory procedure may be used. As the name implies, the two-step inventory procedure may effectively consolidate the messages of the four-step inventory procedure into two messages.

FIG. 8B depicts a process flow diagram of an example two-step inventory procedure 800b performed between the IoT device 804 and the reader 802.

The procedure 800b may begin at 850, where the reader 802 broadcasts and the IoT device 804 receives a query message (MSGA), which may effectively combine MSG0 and MSG2 described above with respect to FIG. 8A.

At 852, the IoT device 804 sends a response (MSGB) to the reader 802, which may effectively combine MSG1 and MSG3 described above with respect to FIG. 8A.

At 854, the reader 802 may send feedback in response to MSGB, for example, as described above with respect to FIG. 8A.

Note that the inventory procedures depicted in FIGS. 8A and 8B are example procedures to facilitate an understanding of certain ambient IoT services communicated between an IoT device and a reader. Additional or alternative signaling may be used for an inventory procedure. Aspects of the present disclosure may be applied to other types of ambient IoT services, such as a communication of a command or configuration addressed to an ambient IoT device.

### Aspects Related to Backscatter Communications in Multi-Static Scenario(s)

Aspects of the present disclosure provide certain scheme(s) for backscatter communications that may mitigate or avoid the near-far effects encountered at a reader in certain multi-static scenarios. The backscatter communications may enable increased reliability, improved channel usage, reduced latencies, and/or the like. The backscatter communications may use spatial multiplexing through beamformed communications. The term “beam” may be used in the present disclosure in various contexts. Beam may be used to mean a set of gains and/or phases (e.g., precoding weights or co-phasing weights) applied to antenna elements in (or associated with) a wireless communication device for transmission or reception. The term “beam” may also refer to an antenna or radiation pattern of a signal transmitted while applying the gains and/or phases to the antenna elements. Other references to beam may include one or more properties or parameters associated with the antenna (or radiation) pattern, such as an angle of arrival (AoA), an angle of departure (AoD), a gain, a phase, a directivity, a beam width, a beam direction (with respect to a plane of reference) in terms of azimuth and/or elevation, a peak-to-side-lobe ratio, and/or an antenna (or precoding) port associated with the antenna (radiation) pattern. The term “beam” may also refer to an associated number and/or configuration of antenna elements (e.g., a uniform linear array, a uniform rectangular array, or other uniform array).

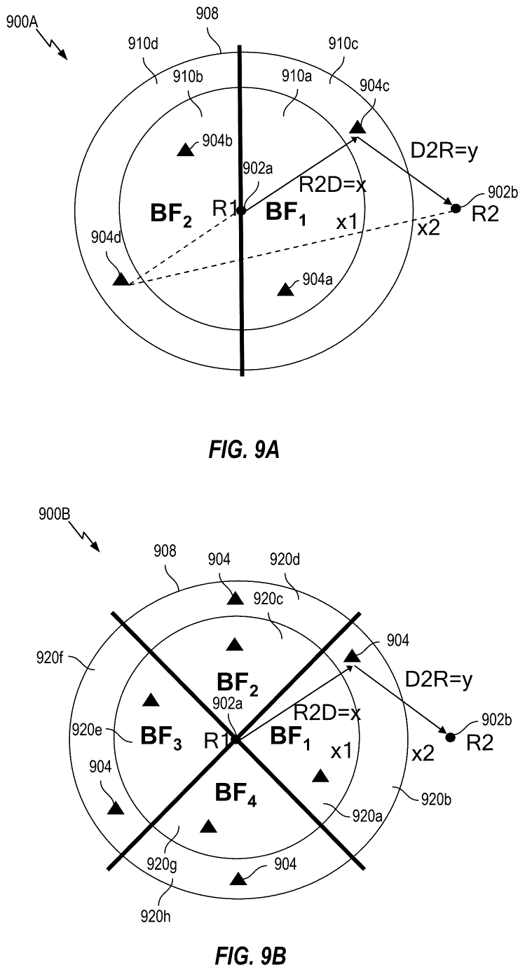

FIGS. 9A and 9B depict example schemes 900A, 900B for backscatter communications in a multi-static scenario. In these examples, a wireless communications system may include a first reader 902a and a second reader 902b that communicate with backscatter devices (for example, the backscatter devices 904a-d in FIG. 9A and the backscatter devices 904 in FIG. 9B) in a multi-static scenario, for example, as described herein with respect to FIG. 7C. The first reader 902a may be an example of the first reader 702a of FIG. 7C, and the second reader 902b may be an example of the second reader 702b of FIG. 7C. Multiple backscatter devices 904 may be located in a coverage area 908 of the first reader 902a. Each of the backscatter devices may be or include a passive or semi-passive IoT device, for example, as described herein with respect to FIGS. 5 and 6. The backscatter devices 904 may be configured to send signal(s) to the second reader 902b based on FDM and/or CDM, for example, as described herein with respect to FIG. 8A. In certain aspects, at least one of the backscatter devices 904 may not be capable of amplifying signal for transmission.

The first reader 902a may perform spatial multiplexing to send transmissions to the backscatter devices 904 within the coverage area 908. The coverage area 908 of the first reader 902a may be effectively segmented into multiple sectors 910, 920 (or sub-areas), for example, via transmit beamforming performed at the first reader 902a. Referring to FIG. 9A, the first reader 902a may be configured to transmit signals via spatial multiplexing across four sectors 910a-d, and with respect to FIG. 9B, the first reader 902a may be configured to transmit signals via spatial multiplexing across eight sectors 920a-h. In certain cases, the first reader 902a may be configured to transmit signals via sectors formed via any number of transmit beams having various beamwidths and/or beam shapes. As used herein, a sector may refer to a portion of a coverage area of a reader, such as the first reader. The first reader 902a may sweep through the sectors 910, 920 to send transmissions to different sets of backscatter devices 904 located in the respective sectors. As an example with respect to FIG. 9A, the first reader 902a may send a first transmission to the first sector 910a and then a second transmission to the second sector 910b.

In certain aspects, the first reader 902a may adjust or determine the transmit power used to transmit a signal to a set of backscatter devices 904 based at least in part on a path loss between a respective backscatter device and the second reader 902b (for example, the path loss associated with the D2R link). The path loss associated with the D2R link may be estimated or determined based on a distance between the backscatter device and the second reader 902b. In certain aspects, the second reader 902b may provide feedback to the first reader 902a, and the first reader 902a may determine the transmit power based on the feedback, which may indicate or include a received signal power of the signals received via the D2R link at the second reader 902b, a latency associated with the signals received at the second reader 902b, and/or the like. The first reader 902a may select the transmit power used to transmit a signal towards a specific sector based on the D2R distance or path loss associated with the sector. For example, the transmit powers may be determined according to the following expression:

$${Ptx}_{BF 1} - {PL}_{P 1 - R 2} = {Ptx}_{BF 2 / BF 4} - {PL}_{P 2 - R 2} = {Ptx}_{BF 3} - {PL}_{P 3 - R 2}$$

where Ptx_{BFi} is the transmit power used to output a signal via a given beam i (e.g., Ptx_{BF1} is the transmit power used to output a signal via the first transmit beam BF1, and so on for transmit beams BF2, BF3, and BF4), and PL_{Pn-R2} is the path loss associated with the D2R link between the second reader 902b and a specific location (Pₙ) in a given sector n (e.g., the first sector 910a) associated with the beam. As an example, PL_{P1-R2} is the path loss associated with the D2R link between the second reader 902b and a location in the first sector 910a associated with the first beam, BF1, such as the location of the first backscatter device 904a. The first reader 902a may select a transmit power that enables the second reader 902b to receive, from a set of backscatter devices, signal(s) within a range of received signal powers that may avoid or mitigate the near-far effect. As an example with respect to FIG. 9A, a first transmit power may be used to transmit signal(s) to the third backscatter device 904c located in the third sector 910c, and a second transmit power may be used to transmit signal(s) to the fourth backscatter device 904d located in the fourth sector 910d. The first transmit power may be less than the second transmit power, for example, due to the third backscatter device 904c being closer to the second reader 902b than the fourth backscatter device 904d.

In certain cases, the Pₙ location in the sector, used to determine the path losses, may be particular locations associated with the sector. As an example, P₂ and/or P₄ may be the center points in the beams BF2 and BF4, respectively, within the annular sectors 910c, 910d. P₁ may be the half way point in the angular part between the lines R1-R2 and the boundary between BF1 and BF2 within the annular ring, and likewise, for P₃. Note that these locations are examples, and aspects of the present disclosure may be applied to alternative or additional locations.

As an example with respect to FIG. 9B, a first transmit power applied to transmissions via a first transmit beam (e.g., BF1) toward the first sector 920a or the second sector 920b (e.g., Ptx_{BF1}<Ptx_{BF2}) may be less than a second transmit power applied to transmissions via a second transmit beam (e.g., BF2) toward the third sector 920c or the fourth sector 920d. A third transmit power applied to the transmissions via a fourth transmit beam (e.g., BF4) toward the seventh sector 920g and the eighth sector 920h may be less than a fourth transmit power applied to transmissions via a third transmit beam (e.g., Ptx_{BF4}<Ptx_{BF3}) toward the fifth sector 920e or the sixth sector 920f.

As an example with respect to FIG. 9A, the first reader 902a may transmit, to a first set of backscatter devices (e.g., the first backscatter device 904a), a first signal via a first transmit beam (e.g., BF1) at a first transmit power in a first transmission occasion. A transmission occasion may be or include a transmission time interval in which signals are communicated (e.g., transmitted and/or received) or scheduled to be communicated. Such a transmission may be beamformed to emit the first signal towards the backscatter device(s) located in the first sector 910a. Then, the first reader 902a may transmit, to a second set of backscatter devices (e.g., the second backscatter device 904b), a second signal via a second transmit beam (e.g., BF2) at a second transmit power in a second transmission occasion. Such a transmission may be beamformed to emit the second signal to the backscatter device(s) located in the second sector 910b. In certain cases, the second transmit power may have a different power level as the first transmit power, for example, to account for the different path loss associated with the D2R link as described above. Accordingly, the first reader 902a may sweep through the remaining sectors of the coverage area 908, such as the third sector 910c and the fourth sector 910d.

In certain aspects, the first reader 902a may gradually adjust (e.g., increase or decrease) the transmit power of signaling with respect to certain transmission occasions to adjust (e.g., increase or decrease) the transmission range and target different sectors associated with a transmit beam. As an example with respect to FIG. 9A, the first reader 902a may transmit a first signal via the first transmit beam (e.g., BF₁) at a first transmit power to target certain backscatter device(s) (e.g., the first backscatter device 904a) located in the first sector 910a. In certain aspects, the first signal may indicate to ignore subsequent signaling addressed to other sectors for a certain duration. Then, the first reader 902a may transmit a second signal via the first transmit beam at a second transmit power (which may be higher than the first transmit power) to target backscatter device(s) (e.g., the third backscatter device 904c) located in the third sector 910c. In certain aspects, the second signal may indicate that the second signal is associated with the third sector 910c, and thus, the first backscatter device 904a may ignore the second signal and refrain from transmitting a response associated with the second signal, for example, as further described herein. In certain cases, the first reader 902a may perform similar or generally the same operations to adjust the transmission range and target different sectors associated with the second transmit beam (e.g., BF₂). As an example, the first reader 902a may gradually increase the transmit power to target backscatter device(s) in the second sector 910b and then the fourth sector 910d.

In certain aspects, the first reader 902a may use the same transmit beam to send transmissions to backscatter devices in different sectors, such as the first sector 910a and the third sector 910c. As an example with respect to FIG. 9A, the first reader 902a may transmit, to a third set of backscatter devices (e.g., the third backscatter device 904c), a third signal via the first transmit beam (e.g., BF₁) at a third transmit power in a third transmission occasion. Such a transmission may be directed to the backscatter device(s) located in the third sector 910c. The third transmit power may have the same or different power level as the first transmit power.

In certain aspects, the first reader 902a may send a transmission via different beams that result in signals being received at the second reader 902b within a range of received signal powers that may avoid or mitigate the near-far effect. The first reader 902a may send a transmission via beams that result in symmetric D2R communication paths (for example, communication paths that have the same path loss and/or distance due to the backscatter devices being symmetrically arranged in different sectors with respect to the first reader 902a and/or the second reader 902b). As an example with respect to FIG. 9B, the first reader 902a may send a signal via the second transmit beam (e.g., BF₂) towards the third sector 920c or the fourth sector 920d and via the fourth transmit beam (e.g., BF₄) towards seventh sector 920g or the eighth sector 920h.

In certain aspects, the first reader 902a may send a signal via different transmit beams if the received signal powers encountered at the second reader 902b are within a threshold range of received signal powers (e.g., ±0.1%, ±1%, ±5%, or the like). In certain cases, the first reader 902a may send a signal to multiple sectors in the same transmission occasion by using different transmit powers for the different sectors. The different transmit powers may be selected to enable the second reader 902b to receive signals from the backscatter devices 904 within a range of received signal powers that may avoid or mitigate the near-far effect. The received signal powers encountered at the second reader may satisfy a threshold range of received signal powers (±5%). As an example with respect to FIG. 9A, the first reader 902a may transmit, to a first set of backscatter devices (e.g., the first backscatter device 904a), a first signal via a first transmit beam (e.g., BF₁) at a first transmit power in a transmission occasion; and the first reader may transmit, to a second set of backscatter device (e.g., the second backscatter device 904b), a second signal via a second transmit beam (e.g., BF₂) at a second transmit power in the transmission occasion. The second transmit power may be greater than the first transmit power.

In certain cases, the transmissions to the backscatter devices 904 from the first reader 902a may be associated with various ambient IoT services, such as an inventory procedure, for example, as described herein with respect to FIGS. 8A and 8B. In such cases, the first reader 902a may send the transmissions associated with an ambient IoT service per sector. As an example, the first reader 902a may send the transmission(s) (e.g., MSG0, MSG2, and MSG4) in a first inventory procedure toward the first sector 910a. Then, the first reader 902a may send the transmission(s) in a second inventory procedure toward the second sector 910b, and so forth for any remaining sectors, for example, including the third sector 910c and the fourth sector 910d.

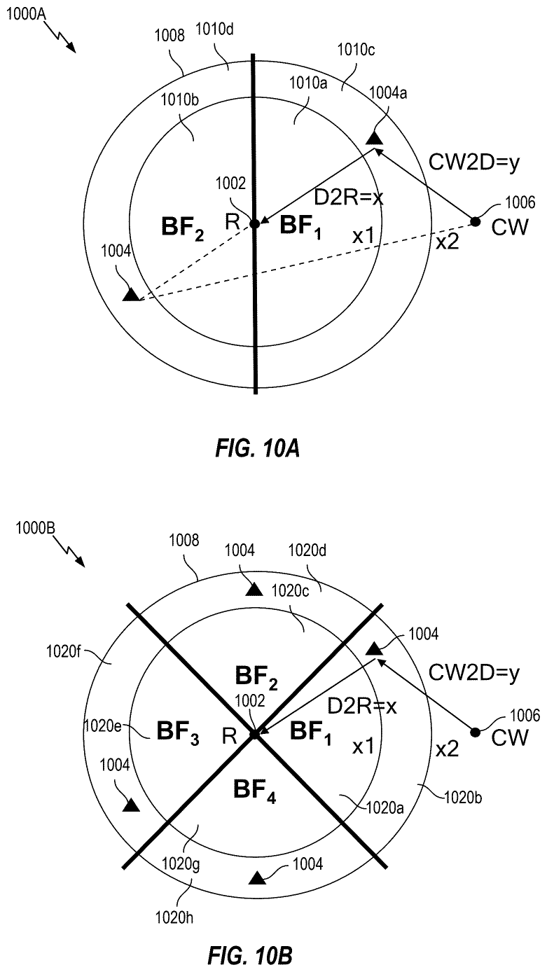

FIGS. 10A and 10B depict example schemes 1000A, 1000B for backscatter communications in a multi-static scenario. In these examples, a wireless communications system may include a reader 1002 and an energy exciter 1006 that may communicate with backscatter devices 1004 in a multi-static scenario, for example, as described herein with respect to FIG. 7B. The reader 1002 may be an example of the reader 702 of FIG. 7B, and the energy exciter 1006 may be an example of the energy exciter 706 of FIG. 7B. Multiple backscatter devices 1004 may be located in a coverage area 1008 of the reader 1002. Each of the backscatter devices 1004 may be or include a passive or semi-passive IoT device, for example, as described herein with respect to FIGS. 5 and 6. The backscatter devices 1004 may be configured to send signals to the reader based on FDM and/or CDM, for example, as described herein with respect to FIG. 8A.

The reader 1002 may perform spatial multiplexing to receive transmissions from the backscatter devices within the coverage area 1008. The coverage area 1008 of the reader 1002 may be effectively segmented into multiple sectors (or sub-areas) 1010a-d, 1020a-h, for example, via receive beamforming performed at the reader 1002. In certain cases, the energy exciter 1006 may be configured to adjust the transmit power of the energy excitation signal to enable the reader 1002 to receive signals from backscatter device(s) 1004 in a corresponding sector toward which the reader 1002 is monitoring for signaling via receive beamforming. Referring to FIG. 10A, the reader 1002 may be configured to receive signals via spatial multiplexing (and excitation signal power adjustments) across four sectors 1010a-d, and with respect to FIG. 10B, the reader 1002 may be configured to receive signals via spatial multiplexing (and excitation signal power adjustments) across eight sectors 1020a-h. The reader 1002 may sweep through the sectors 1010, 1020 to receive transmissions from different sets of backscatter devices 1004 located in the respective sectors, while the energy exciter 1006 may send the excitation signal at different transmit powers to account for the variation in received signal powers encountered at the backscatter devices associated with the CW2D link across the different sectors.

As an example with respect to FIG. 10A, the reader 1002 may obtain a first signal from a first backscatter device 1004a in the third sector 1010c and then obtain a second signal from a second backscatter device 1004b in the fourth sector 1010d. The energy exciter 1006 may send a first energy excitation signal at a first transmit power to enable the first backscatter device 1004a to send the first signal, and then the energy exciter 1006 may send a second energy excitation signal at a second transmit power to enable the second backscatter device 1004b to send the second signal.

Aspects associated with the spatial multiplexing described herein with respect to FIGS. 9A and 9B may be applied in the context of receive beamforming and/or the excitation signal power adjustments with respect to FIGS. 10A and 10B. In certain aspects, the reader 1002 may monitor for signaling via multiple receive beams that have symmetric D2R communication paths. As an example with respect to FIG. 10B, the reader 1002 may obtain signals from backscatter device(s) 1004 via the second receive beam (e.g., BF₂) towards the third sector 1020c or the fourth sector 1020d and via the fourth receive beam (e.g., BF₄) towards the seventh sector 1020g or the eighth sector 1020h. In certain aspects, the energy exciter 1006 may adjust or determine the transmit power of the excitation signal based at least in part on the path loss associated with the CW2D link. For example, the transmit powers may be determined according to the following expression:

$${P}_{BF 1} - {PL}_{CW 2 P 1} = {P}_{BF 2 / BF 4} - {PL}_{CW 2 P 2} = {P}_{BF 3} - {PL}_{CW 2 P 3}$$

where P_{BFi} is the transmit power used to output an excitation signal associated with a given beam i (e.g., P_{BF1} is the transmit power used to output the excitation signal associated with the first beam BF₁), and PL_{CW2Pn} is the path loss associated with the CW2D link between the energy exciter 1006 and a specific location in a given sector n (e.g., the first sector 1010a) associated with the beam. For example, PL_{CW2P1} is the path loss associated with the CW2D link between the energy exciter 1006 and a location in the first sector 1010a, which may be selected as described herein with respect to FIGS. 9A and 9B. In certain cases, the reader 1002 may obtain signals via multiple receive beams in the same transmission occasion if the received signal powers are within a threshold range of received signal powers.

In certain aspects, a reader (the first reader 902a of FIGS. 9A and 9B and/or the reader 1002 of FIGS. 10A and 10B) may send, to a set of backscatter devices located in a sector, an indication to ignore certain signaling associated with another sector for a certain time period (e.g., 500 milliseconds, 30 seconds, 1 minute, or the like). As an example, a reader may send a query message that may indicate a sector to which an inventory procedure is linked or addressed. If a backscatter device receives the query message and sends a reply associated with that sector (and/or receives an ACK), the backscatter device may ignore subsequent signaling associated with a different sector, such as a subsequent query message that indicates an association with the other sector. The indication to ignore signaling may be included in ACK-NACK feedback (e.g., MSG4), a query message of an inventory procedure (e.g., MSG0 or MSGA), a command message associated with an IoT command service, dedicated signaling, and/or the like. Such an indication may allow the reader to target communications with certain backscatter devices located in a given sector, and thus avoid or mitigate near-far effects. In certain cases, the reader and/or the energy exciter may gradually adjust the transmit power to target different sectors at different transmission occasions, for example, as described herein with respect to FIG. 9A.

Accordingly, the spatial multiplexing described herein with respect to FIGS. 9A-10B may allow a reader to receive signals from certain backscatter devices within a range of received signal powers that avoid or mitigate the near-far effect. The respective reader may successfully detect and decode the signals received from the backscatter devices with increased reliability, which may enable improved channel usage and/or reduced latencies.

Note that the spatial multiplexing depicted in FIGS. 9A-10B are examples that depict azimuthal segmentation of a coverage area associated with a reader to facilitate an understanding of backscatter communications that may avoid or mitigate the near-far effect. Aspects of the present disclosure may be applied to other suitable types of spatial multiplexing, such as transmit and/or receive beamforming in elevation and/or azimuth directions. In certain cases, alternative or additional sectors with respect to FIGS. 9A-10B may be formed or used through transmit and/or receive beamforming at the respective reader.

### Example Signaling of Backscatter Communications in Multi-Static Scenario(s)

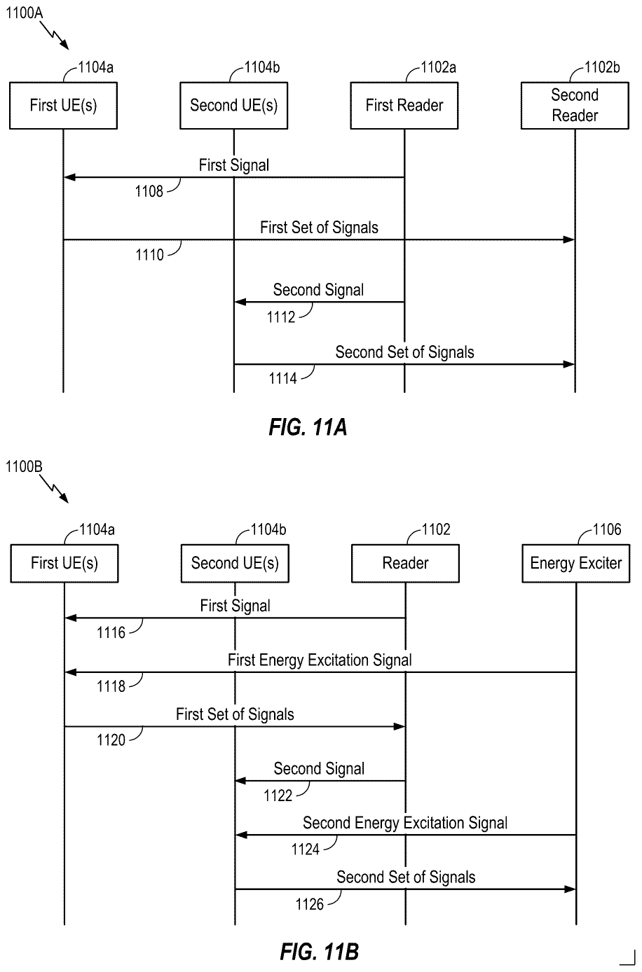

FIG. 11A depicts a process flow 1100A for backscatter communications in a system that includes a first reader 1102a, a second reader 1102b, a first UE 1104a, and a second UE 1104b. In certain aspects, the reader 1102a, 1102b may be an example of the BS 102 depicted and described with respect to FIG. 1, the first network entity 300 or the second network entity 302 depicted and described with respect to FIG. 3, or a disaggregated base station depicted and described with respect to FIG. 2. In certain aspects, the reader 1102a, 1102b may be an example of UE 104 depicted and described with respect to FIG. 1 or the UE 304 depicted and described with respect to FIG. 3. Similarly, the UE 1104a, 1104b may be an example of UE 104 depicted and described with respect to FIG. 1 or the UE 304 depicted and described with respect to FIG. 3. In certain aspects, each of the first UE 1104a and the second UE 1104b may be an example of one or more backscatter devices, which may be or include a passive or semi-passive IoT device, for example, as described herein with respect to FIGS. 5 and 6. However, in other aspects, UE 1104a, 1104b may be another type of wireless communications device, and the reader 1102a, 1102b may be another type of network entity or network node, such as those described herein. Note that any operations or signaling illustrated with dashed lines may indicate that that operation or signaling is an optional or alternative example.

In this example, the first reader 1102a and the second reader 1102b may be in a multi-static scenario, for example, as described herein with respect to FIGS. 7C, 9A, and 9B. The first reader 1102a may be an example of the first reader 702a of FIG. 7C and/or the first reader 902a of FIGS. 9A and 9B; and the second reader 1102b may be an example of the second reader 702b of FIG. 7C and/or the second reader 902b of FIGS. 9A and 9B. The first UE 1104a and the second UE 1104b may be located in different sectors associated with the first reader 1102a, for example, as described herein with respect to FIGS. 9A and 9B. As an example, the first UE 1104a may be located in the first sector 920a of FIG. 9B, and the second UE 1104b may be located in the second sector 920b of FIG. 9B.

At 1108, the first UE 1104a obtains, from the first reader 1102a, a first signal in one or more first transmission occasions. The first reader 1102a sends, to the first UE 1104a, the first signal via a first transmit beam at a first transmit power in the first transmission occasion(s). The first reader 1102a may communicate with the first UE 1104a via spatial multiplexing as described herein with respect to FIGS. 9A and 9B. As an example, the first transmit beam may orient the first signal toward the sector in which the first UE 1104a is located. The first transmit beam may form an AoD toward the sector (e.g., the first sector 920a). The first transmit power may be determined based on a path loss associated with a D2R link between the first UE 1104a and the second reader 1102b, for example, as described herein with respect to FIGS. 9A and 9B. In certain cases, the first signal may include an energy excitation signal and/or a signal that carries data and/or information, such as a query message, a D2R link grant, and/or ACK-NACK feedback.

At 1110, the first UE 1104a sends, to the second reader 1102b, a first set of signals in one or more second transmission occasions. In certain aspects, the first UE 1104a may backscatter the first set of signals based on a received energy excitation signal. As an example, the first UE 1104a may receive an excitation signal from the first reader 1102a, and then, the first UE 1104a may modulate the excitation signal and reflect the modulated signal, which may be part of the first set of signals. The second reader 1102b obtains, from the first UE 1104a, the first set of signals within a first set of received signal powers in the second transmission occasion(s). In certain aspects, the second reader 1102b may obtain the first set of signals via a first receive beam, which may be directed toward the location of the first UE 1104a, for example, in terms of an AoA. In certain aspects, the first signal and the first set of signals may be communicated as part of an inventory procedure (for example, as described herein with respect to FIGS. 8A and 8B) or any other suitable IoT service. In certain cases, the first signal may include an indication of a sector to which the first signal is addressed or linked. Such an indication may indicate for the first UE 1104a to ignore subsequent signaling (such as the second signal at 1112) associated with other sector(s) for a certain time period, for example, as described herein.

The first set of received signals powers may be within a range of received signal powers that satisfies a threshold range (e.g., ±1%, ±5%, or the like). The threshold range may allow any near-far effects to be mitigated or avoided at the second reader 1102b. Accordingly, the second reader 1102b may successfully detect and decode the first set of signals without retransmissions from the first UE 1104a. Thus, the spatial multiplexing directed toward the first UE 1104a may enable backscatter communications with increased reliability, reduced latencies, and/or improved channel usage.

At 1112, the second UE 1104b obtains, from the first reader 1102a, a second signal in one or more third transmission occasions. The first reader 1102a sends, to the second UE 1104b, the second signal via a second transmit beam at a second transmit power in the third transmission occasion(s). The first reader 1102a may communicate with the second UE 1104b via spatial multiplexing as described herein with respect to FIGS. 9A and 9B. As an example, the second transmit beam may orient the second signal toward the sector in which the second UE 1104b is located. The second transmit beam may form an AoD toward the sector (e.g., the second sector 920b). The second transmit beam may be different from the first transmit beam. The second transmit power may be determined based on a path loss associated with a D2R link between the second UE 1104b and the second reader 1102b, for example, as described herein with respect to FIGS. 9A and 9B. In certain cases, the first signal may include an energy excitation signal and/or a signal that carries data and/or information, such as a query message, a D2R link grant, and/or ACK-NACK feedback.

At 1114, the second UE 1104b sends, to the second reader 1102b, a second set of signals in one or more fourth transmission occasions. In certain aspects, the second UE 1104b may backscatter the second set of signals based on a received energy excitation signal, for example, as described herein. The second reader 1102b obtains, from the second UE 1104b, the second set of signals within a second set of received signal powers in the fourth transmission occasion(s). In certain aspects, the second reader 1102b may obtain the second set of signals via a second receive beam, which may be directed toward the location of the second UE 1104b, for example, in terms of an AoA. The second receive beam may be different from the first receive beam.

In certain aspects, the second signal and the second set of signals may be communicated as part of an inventory procedure (for example, as described herein with respect to FIGS. 8A and 8B) or any other suitable IoT service. In certain cases, the second signal may include an indication of a sector to which the second signal is addressed or linked. Such an indication may indicate for the first UE 1104a to ignore the second signal. Accordingly, if the first UE 1104a obtains the second signal, the first UE 1104a may refrain from sending a reply associated with the second signal.

FIG. 11B depicts a process flow 1100B for backscatter communications in a network that includes a reader 1102, an energy exciter 1106, a first UE 1104a, and a second UE 1104b. In certain aspects, the reader 1102 and/or the energy exciter 1106 may be an example of the BS 102 depicted and described with respect to FIG. 1, the first network entity 300 or the second network entity 302 depicted and described with respect to FIG. 3, or a disaggregated base station depicted and described with respect to FIG. 2. In certain aspects, the reader 1102 and/or the energy exciter 1106 may be an example of UE 104 depicted and described with respect to FIG. 1 or the UE 304 depicted and described with respect to FIG. 3. Similarly, the UE 1104a, 1104b may be an example of UE 104 depicted and described with respect to FIG. 1 or the UE 304 depicted and described with respect to FIG. 3. In certain aspects, each of the first UE 1104a and the second UE 1104b may be an example of one or more backscatter devices, which may be or include a passive or semi-passive IoT device, for example, as described herein with respect to FIGS. 5 and 6. However, in other aspects, UE 1104a, 1104b may be another type of wireless communications device, and the reader 1102 and/or the energy exciter 1106 may be another type of network entity or network node, such as those described herein. Note that any operations or signaling illustrated with dashed lines may indicate that that operation or signaling is an optional or alternative example.

In this example, the reader 1102 and the energy exciter 1106 may be in a multi-static scenario, for example, as described herein with respect to FIGS. 7B, 10A, and 10B. The reader 1102 may be an example of the reader 702 of FIG. 7B and/or the reader 1002 of FIGS. 10A and 10B, and the energy exciter 1106 may be an example of the energy exciter 706 of FIG. 7B and/or the energy exciter 1006 of FIGS. 10A and 10B. The first UE 1104a and the second UE 1104b may be located in different sectors associated with the reader 1102a, for example, as described herein with respect to FIGS. 10A and 10B. As an example, the first UE 1104a may be located in the first sector 1020a of FIG. 10B, and the second UE 1104b may be located in the second sector 1020b of FIG. 10B.

At 1116, the first UE 1104a obtains, from the reader 1102, a first signal in one or more first transmission occasions. The reader 1102 may send, to the first UE 1104a, the first signal via a first beam at a first transmit power in the first transmission occasion(s). As an example, the first beam may orient the first signal toward the sector in which the first UE 1104a is located. The first beam may form an AoA toward the sector (e.g., the first sector 1020a). In certain cases, the first signal may include an indication of a sector to which the first signal is addressed or linked. Such an indication may indicate for the first UE 1104a to ignore subsequent signaling (such as the second signal at 1122) associated with other sector(s) for a certain time period, for example, as described herein.

At 1118, the first UE 1104a obtains, from the energy exciter 1106, a first energy excitation signal. The energy exciter 1106 sends the first energy excitation signal at a second transmit power, for example, based on a path loss of the CW2D link between the first UE 1104a and the energy exciter 1106, as described herein with respect to FIGS. 10A and 10B. In certain cases, the first energy excitation signal may be communicated concurrently with the first signal in the first transmission occasion(s). In certain cases, the first energy excitation signal may be communicated after the first signal. The first energy excitation signal may be or include an RF signal having a continuous wave or any suitable waveform that is capable of supplying a backscatter device and/or passive or semi-passive IoT device with energy for wireless communications, for example, as described herein with respect to FIGS. 5 and 6.

At 1120, the first UE 1104a sends, to the reader 1102, a first set of signals in one or more second transmission occasions. In certain aspects, the first UE 1104a may backscatter the first set of signals based on the first energy excitation signal received at 1118, for example, as described herein. The reader 1102 may communicate with the first UE 1104a via spatial multiplexing as described herein with respect to FIGS. 10A and 10B. The reader 1102 obtains, from the first UE 1104a, the first set of signals via the first beam within a first set of received signal powers in the second transmission occasion(s). In this case, the first beam may form an AoA toward the sector in which the first UE 1104a is located. In certain aspects, the first signal and the first set of signals may be communicated as part of an inventory procedure (for example, as described herein with respect to FIGS. 8A and 8B) or any other suitable IoT service. The first set of received signals powers may be within a range of received signal powers that satisfies a threshold range (e.g., ±1%, ±5%, or the like), as described herein. Accordingly, the spatial multiplexing described herein may enable backscatter communications with increased reliability, reduced latencies, and/or improved channel usage.

At 1122, the second UE 1104b obtains, from the reader 1102, a second signal in one or more third transmission occasions. The reader 1102 may send, to the second UE 1104b, the second signal via a second beam at a third transmit power in the third transmission occasion(s). As an example, the second beam may orient the second signal toward the sector in which the second UE 1104b is located. The second beam may form an AoD toward the sector (e.g., the second sector 1020b).

At 1124, the second UE 1104b obtains, from the energy exciter 1106, a second energy excitation signal. The energy exciter 1106 sends the second energy excitation signal at a fourth transmit power, for example, based on a path loss of the CW2D link between the second UE 1104b and the energy exciter 1106, as described herein with respect to FIGS. 10A and 10B. In certain cases, the second energy excitation signal may be communicated concurrently with the second signal in the third transmission occasion(s). In certain cases, the second energy excitation signal may be communicated after the second signal. The second energy excitation signal may be or include an RF signal having a continuous wave.

At 1126, the second UE 1104b sends, to the reader 1102, a second set of signals in one or more fourth transmission occasions. In certain aspects, the second UE 1104b may backscatter the second set of signals based on the second energy excitation signal received at 1124, for example, as described herein. The reader 1102 may communicate with the second UE 1104b via spatial multiplexing as described herein with respect to FIGS. 10A and 10B. The reader 1102 obtains, from the second UE 1104b, the second set of signals via the second beam within a second set of received signal powers in the fourth transmission occasion(s). In this case, the second beam may form an AoA toward the sector in which the second UE 1104b is located.

In certain aspects, the second signal and the second set of signals may be communicated as part of an inventory procedure (for example, as described herein with respect to FIGS. 8A and 8B) or any other suitable IoT service. In certain cases, the second signal may include an indication of a sector to which the second signal is addressed or linked. Such an indication may indicate for the first UE 1104a to ignore the second signal. Accordingly, if the first UE 1104a obtains the second signal, the first UE 1104a may refrain from sending a reply associated with the second signal.

Note that the process flows illustrated in FIGS. 11A and 11B are described herein to facilitate an understanding of backscatter communications in multi-static scenarios, and aspects of the present disclosure may be performed in various manners via alternative or additional signaling and/or operations. In certain aspects, the operations and/or signaling of FIGS. 11A and 11B may occur in an order different from that described or depicted, and various actions, operations, and/or signaling may be added, omitted, or combined.

### Example Operations of Backscatter Communications in Multi-Static Scenario(s)

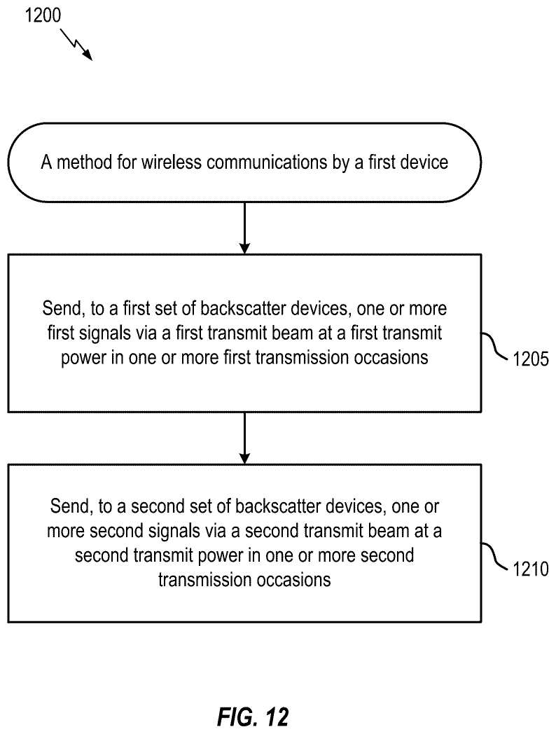

FIG. 12 shows a method 1200 for wireless communications by a first device, such as UE 104 of FIG. 1, UE 304 of FIG. 3, BS 102 of FIG. 1, a first network entity 300 or second network entity 302 of FIG. 3, and/or a disaggregated base station as discussed with respect to FIG. 2.

Method 1200 begins at block 1205 with sending, to a first set of backscatter devices, one or more first signals via a first transmit beam at a first transmit power in one or more first transmission occasions, for example, as described herein with respect to FIGS. 7C, 9A, 9B, and 11A.

Method 1200 then proceeds to block 1210 with sending, to a second set of backscatter devices, one or more second signals via a second transmit beam at a second transmit power in one or more second transmission occasions, for example, as described herein with respect to FIGS. 7C, 9A, 9B, and 11A.

In certain aspects, the first set of backscatter devices includes a first backscatter device; the second set of backscatter devices includes a second backscatter device that is different from the first backscatter device; the first transmit beam is different from the second transmit beam; the first transmit power is different from the second transmit power; and the one or more first transmission occasions are non-overlapping in time with the one or more second transmission occasions.

In certain aspects, method 1200 further includes sending, to a third set of backscatter devices, one or more third signals via the first transmit beam at a third transmit power in one or more third transmission occasions.

In certain aspects, the first transmit power is based at least in part on a first path loss between the first set of backscatter devices and a second device; and the second transmit power is based at least in part on a second path loss between the second set of backscatter devices and the second device.

In certain aspects, block 1205 includes sending the one or more first signals via the first transmit beam and a third transmit beam.

In certain aspects, block 1205 includes sending the one or more first signals in a first inventory procedure; and block 1210 includes sending the one or more second signals in a second inventory procedure.

In certain aspects, the one or more first signals includes one or more of a query message, a D2R link grant, an acknowledgement message, or a negative acknowledgement message, for example, as described herein with respect to FIGS. 8A and 8B.

In certain aspects, the D2R link grant indicates a sequence associated with communication based at least in part on code division multiplexing.

In certain aspects, the D2R link grant indicates one or more time-frequency resources associated with communication based at least in part on frequency division multiplexing.

In certain aspects, the first device includes a first network node; and the first set of backscatter devices includes an ambient IoT device.

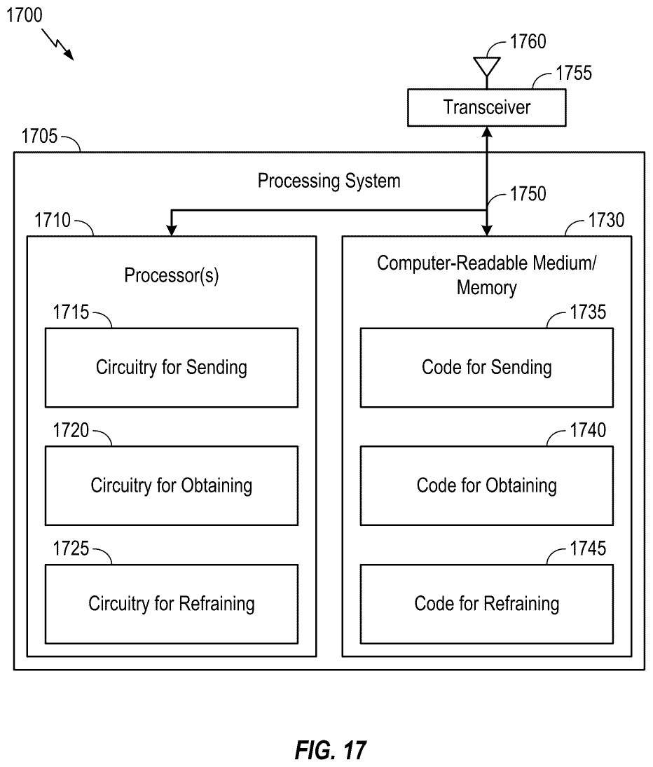

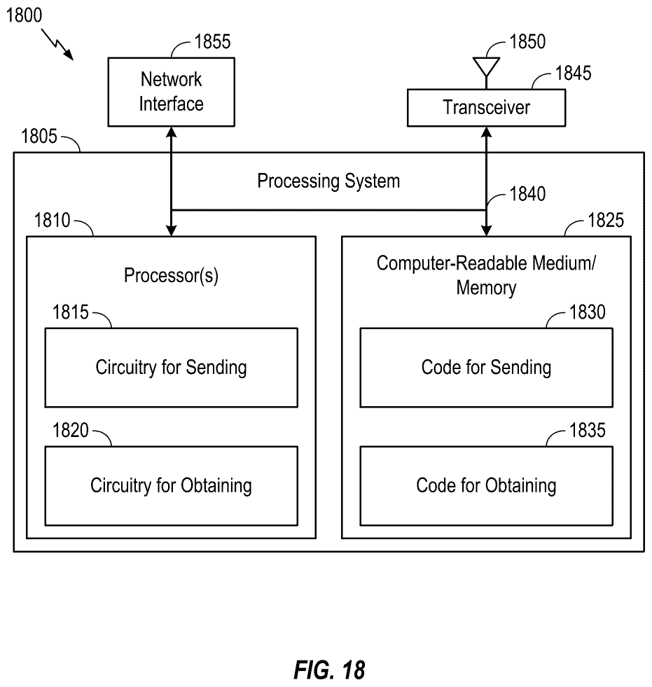

In certain aspects, method 1200, or any aspect related to it, may be performed by an apparatus, such as communications device 1700 of FIG. 17 and/or communications device 1800 of FIG. 18, which include various components operable, configured, or adapted to perform the method 1200. Communications device 1700 and communications device 1800 are described below in further detail.

Note that FIG. 12 is just one example of a method, and other methods including fewer, additional, or alternative operations are possible consistent with this disclosure.

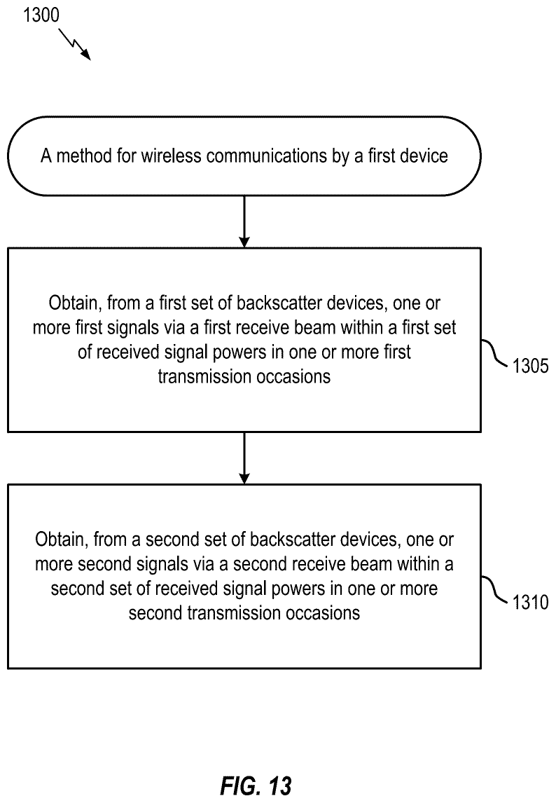

FIG. 13 shows a method 1300 for wireless communications by a first device, such as UE 104 of FIG. 1, UE 304 of FIG. 3, BS 102 of FIG. 1, a first network entity 300 or second network entity 302 of FIG. 3, and/or a disaggregated base station as discussed with respect to FIG. 2.

Method 1300 begins at block 1305 with obtaining, from a first set of backscatter devices, one or more first signals via a first receive beam within a first set of received signal powers in one or more first transmission occasions, for example, as described herein with respect to FIGS. 7C, 9A, 9B, and 11A.

Method 1300 then proceeds to block 1310 with obtaining, from a second set of backscatter devices, one or more second signals via a second receive beam within a second set of received signal powers in one or more second transmission occasions, for example, as described herein with respect to FIGS. 7C, 9A, 9B, and 11A.

In certain aspects, the first set of backscatter devices includes a first backscatter device; the second set of backscatter devices includes a second backscatter device that is different from the first backscatter device; the first receive beam is different from the second receive beam; the first set of received signal powers devices includes a first received signal power; the second set of received signal powers includes a second received signal power that is different from the first received signal power; and the one or more first transmission occasions are non-overlapping in time with the one or more second transmission occasions.

In certain aspects, method 1300 further includes obtaining an indication of a first schedule that indicates the one or more first transmission occasions and a second schedule that indicates the one or more second transmission occasions.

In certain aspects, method 1300 further includes obtaining, from a third set of backscatter devices, one or more third signals via the first receive beam within a third set of received signal powers in one or more third transmission occasions.

In certain aspects, the first set of received signal powers is based at least in part on a path loss between the first set of backscatter devices and the first device.

In certain aspects, block 1305 includes obtaining the one or more first signals via the first receive beam and a third receive beam.

In certain aspects, block 1305 includes obtaining the one or more first signals in a first inventory procedure; and block 1310 includes obtaining the one or more second signals in a second inventory procedure.

In certain aspects, the one or more first signals includes one or more of a response message, a device identifier (e.g., an asset identifier, an electronic product code, or the like), or device information (e.g., a device or asset state, sensor data or measurements, or the like).

In certain aspects, block 1305 includes obtaining the one or more first signals based at least in part on code division multiplexing.

In certain aspects, block 1305 includes obtaining the one or more first signals based at least in part on frequency division multiplexing.

In certain aspects, the first device includes a first network node; and the first set of backscatter devices includes an ambient IoT device.

In certain aspects, method 1300, or any aspect related to it, may be performed by an apparatus, such as communications device 1700 of FIG. 17 and/or communications device 1800 of FIG. 18, which include various components operable, configured, or adapted to perform the method 1300. Communications device 1700 and communications device 1800 are described below in further detail.

Note that FIG. 13 is just one example of a method, and other methods including fewer, additional, or alternative operations are possible consistent with this disclosure.

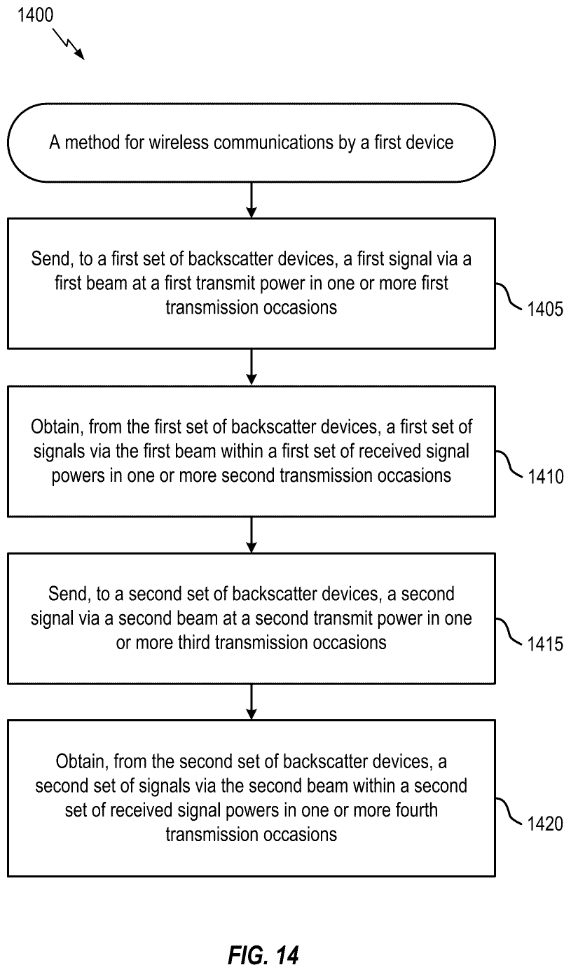

FIG. 14 shows a method 1400 for wireless communications by a first device, such as UE 104 of FIG. 1, UE 304 of FIG. 3, BS 102 of FIG. 1, a first network entity 300 or second network entity 302 of FIG. 3, and/or a disaggregated base station as discussed with respect to FIG. 2.

Method 1400 begins at block 1405 with sending, to a first set of backscatter devices, a first signal via a first beam at a first transmit power in one or more first transmission occasions, for example, as described herein with respect to FIGS. 7B, 10A, 10B, and 11B.

Method 1400 then proceeds to block 1410 with obtaining, from the first set of backscatter devices, a first set of signals via the first beam within a first set of received signal powers in one or more second transmission occasions, for example, as described herein with respect to FIGS. 7B, 10A, 10B, and 11B.

Method 1400 then proceeds to block 1415 with sending, to a second set of backscatter devices, a second signal via a second beam at a second transmit power in one or more third transmission occasions, for example, as described herein with respect to FIGS. 7B, 10A, 10B, and 11B.

Method 1400 then proceeds to block 1420 with obtaining, from the second set of backscatter devices, a second set of signals via the second beam within a second set of received signal powers in one or more fourth transmission occasions, for example, as described herein with respect to FIGS. 7B, 10A, 10B, and 11B.

In certain aspects, the first set of backscatter devices includes a first backscatter device; the second set of backscatter devices includes a second backscatter device that is different from the first backscatter device; the first beam is different from the second beam; the first transmit power is different from the second transmit power; the first set of received signal powers devices includes a first received signal power; the second set of received signal powers includes a second received signal power that is different from the first received signal power; and the one or more first transmission occasions are non-overlapping in time with the one or more second transmission occasions; the one or more second transmission occasions are non-overlapping in time with the one or more third transmission occasions; and the one or more third transmission occasions are non-overlapping in time with the one or more fourth transmission occasions.

In certain aspects, method 1400 further includes sending, to a second device, an indication of a schedule that indicates a set of transmit powers for communication of energy excitation signaling in at least the one or more second transmission occasions and the one or more fourth transmission occasions.

In certain aspects, at least one transmit power of the set of transmit powers is based at least in part on a path loss between the first set of backscatter devices and the first device.

In certain aspects, method 1400 further includes sending, to a third set of backscatter devices, a third signal via the first beam at a third transmit power in one or more fifth transmission occasions.

In certain aspects, method 1400 further includes obtaining, from the third set of backscatter devices, a third set of signals via the first beam within a third set of received signal powers in one or more sixth transmission occasions.

In certain aspects, the first transmit power is based on a path loss between the first set of backscatter devices and the first device.

In certain aspects, block 1405 includes sending the first signal via the first beam and a third beam.

In certain aspects, block 1405 includes sending the first signal in a first inventory procedure; block 1410 includes obtaining the first set of signals in the first inventory procedure; block 1415 includes sending the second signal in a second inventory procedure; and block 1420 includes obtaining the second set of signals in the second inventory procedure.

In certain aspects, the first signal includes one or more of a query message, a D2R link grant, an acknowledgement message, or a negative acknowledgement message; and the first set of signals includes one or more of a response message, a device identifier, or device information.

In certain aspects, the D2R link grant indicates a sequence associated with communication based at least in part on code division multiplexing.

In certain aspects, the D2R link grant indicates one or more time-frequency resources associated with communication based at least in part on frequency division multiplexing.

In certain aspects, the first device includes a first network node; and the first set of backscatter devices includes an ambient IoT device.

In certain aspects, method 1400, or any aspect related to it, may be performed by an apparatus, such as communications device 1700 of FIG. 17 and/or communications device 1800 of FIG. 18, which include various components operable, configured, or adapted to perform the method 1400. Communications device 1700 and communications device 1800 are described below in further detail.

Note that FIG. 14 is just one example of a method, and other methods including fewer, additional, or alternative operations are possible consistent with this disclosure.

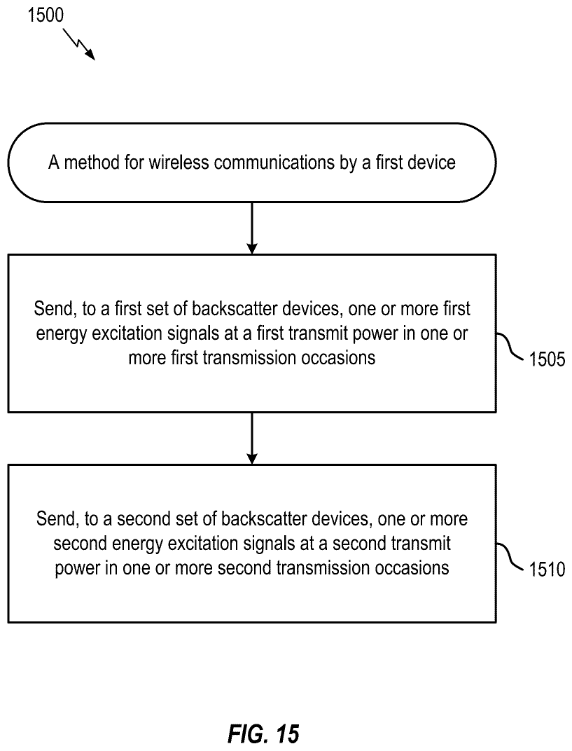

FIG. 15 shows a method 1500 for wireless communications by a first device, such as UE 104 of FIG. 1, UE 304 of FIG. 3, BS 102 of FIG. 1, a first network entity 300 or second network entity 302 of FIG. 3, and/or a disaggregated base station as discussed with respect to FIG. 2.

Method 1500 begins at block 1505 with sending, to a first set of backscatter devices, one or more first energy excitation signals at a first transmit power in one or more first transmission occasions, for example, as described herein with respect to FIGS. 7B, 10A, 10B, and 11B.

Method 1500 then proceeds to block 1510 with sending, to a second set of backscatter devices, one or more second energy excitation signals at a second transmit power in one or more second transmission occasions, for example, as described herein with respect to FIGS. 7B, 10A, 10B, and 11B.

In certain aspects, the first set of backscatter devices includes a first backscatter device; the second set of backscatter devices includes a second backscatter device that is different from the first backscatter device; the first transmit power is different from the second transmit power; and the one or more first transmission occasions are non-overlapping in time with the one or more second transmission occasions.

In certain aspects, the one or more first energy excitation signals includes a continuous wave.

In certain aspects, method 1500 further includes obtaining, from a second device, an indication of a schedule that indicates a set of transmit powers for communication of energy excitation signaling in at least the one or more first transmission occasions and the one or more second transmission occasions.

In certain aspects, at least one transmit power of the set of transmit powers is based on a path loss between a backscatter device and the second device.

In certain aspects, the first transmit power is based on a path loss between a backscatter device and a second device.

In certain aspects, the one or more first transmission occasions are associated with a first inventory procedure; and the one or more second transmission occasions are associated with a second inventory procedure.

In certain aspects, the first device includes a radio frequency energy exciter; and the first set of backscatter devices includes an ambient IoT device.

In certain aspects, method 1500, or any aspect related to it, may be performed by an apparatus, such as communications device 1700 of FIG. 17 and/or communications device 1800 of FIG. 18, which include various components operable, configured, or adapted to perform the method 1500. Communications device 1700 and communications device 1800 are described below in further detail.

Note that FIG. 15 is just one example of a method, and other methods including fewer, additional, or alternative operations are possible consistent with this disclosure.

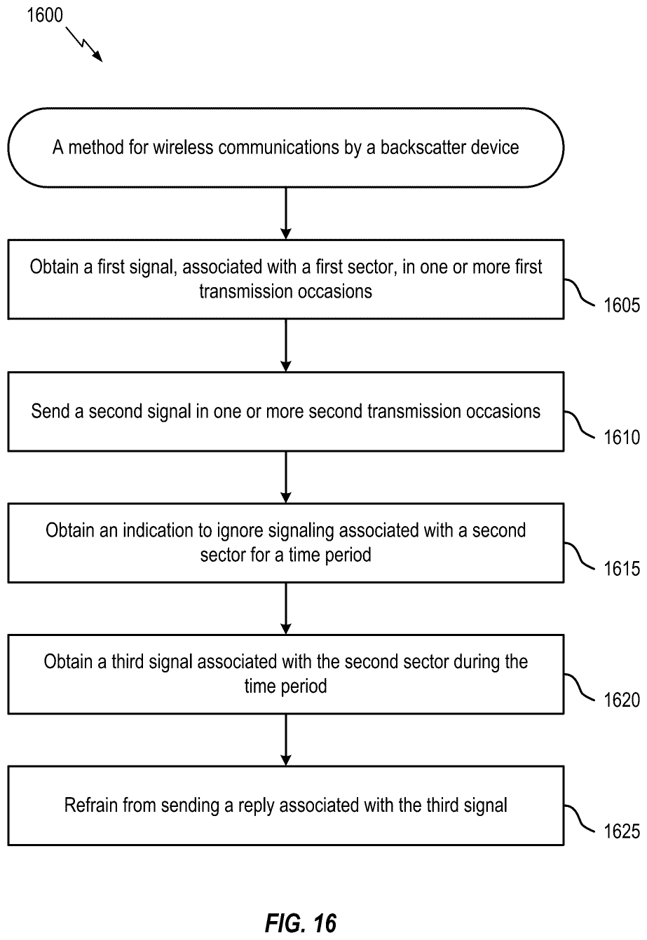

FIG. 16 shows a method 1600 for wireless communications by a backscatter device, such as UE 104 of FIG. 1 or UE 304 of FIG. 3. In certain aspects, the backscatter device may be or include a passive or semi-passive IoT device, for example, as described herein with respect to FIGS. 5 and 6.

Method 1600 begins at block 1605 with obtaining a first signal, associated with a first sector, in one or more first transmission occasions, for example, as described herein with respect to FIGS. 7B, 7C, and 9A-11B.

Method 1600 then proceeds to block 1610 with sending a second signal in one or more second transmission occasions, for example, as described herein with respect to FIGS. 7B, 7C, and 9A-11B.

Method 1600 then proceeds to block 1615 with obtaining an indication to ignore signaling associated with a second sector for a time period, for example, as described herein with respect to FIGS. 7B, 7C, and 9A-11B.

Method 1600 then proceeds to block 1620 with obtaining a third signal associated with the second sector during the time period, for example, as described herein with respect to FIGS. 9A-11B.

Method 1600 then proceeds to block 1625 with refraining from sending a reply associated with the third signal, for example, as described herein with respect to FIGS. 9A-11B.

In certain aspects, the first sector is different from the second sector; and the one or more first transmission occasions are non-overlapping in time with the one or more second transmission occasions.

In certain aspects, the indication to ignore signaling includes an acknowledgement message that indicates to ignore the signaling associated with the second sector.

In certain aspects, the third signal includes a query message that includes the indication to ignore the signaling.

In certain aspects, the first signal includes an indication of the first sector.

In certain aspects, method 1600 further includes obtaining an energy excitation signal from a radio frequency energy exciter, wherein block 1610 includes sending a backscatter of the energy excitation signal, wherein the backscatter includes the second signal.

In certain aspects, block 1605 includes obtaining the first signal from a first network node; and block 1610 includes sending the second signal to a second network node.

In certain aspects, block 1605 includes obtaining the first signal from a network node; and block 1610 includes sending the second signal to the network node.

In certain aspects, block 1605 includes obtaining the first signal in an inventory procedure; and block 1610 includes sending the second signal in the inventory procedure.

In certain aspects, the first signal includes one or more of a query message, a D2R link grant, an acknowledgement message, or a negative acknowledgement message; and the second signal includes one or more of a response message, a device identifier, or device information.

In certain aspects, the backscatter device includes an ambient IoT device.

In certain aspects, method 1600, or any aspect related to it, may be performed by an apparatus, such as communications device 1700 of FIG. 17, which includes various components operable, configured, or adapted to perform the method 1600. Communications device 1700 is described below in further detail.

Note that FIG. 16 is just one example of a method, and other methods including fewer, additional, or alternative operations are possible consistent with this disclosure.

### Example Communications Devices

FIG. 17 depicts aspects of an example communications device 1700 configured for wireless communications. In certain aspects, communications device 1700 is a user equipment, such as UE 104 described above with respect to FIG. 1 or UE 304 described with respect to FIG. 3. In certain aspects, the communications device 1700 may be or include be or include a backscatter device, such as a passive or semi-passive IoT device, for example, as described herein with respect to FIGS. 5 and 6

The communications device 1700 includes a processing system 1705 coupled to a transceiver 1755 (e.g., a transmitter and/or a receiver). The transceiver 1755 is configured to transmit and receive signals for the communications device 1700 via an antenna 1760, such as the various signals as described herein. The processing system 1705 may be configured to perform processing functions for the communications device 1700, including processing signals received and/or to be transmitted by the communications device 1700.

The processing system 1705 includes one or more processors 1710 and a computer-readable medium/memory 1730. In various aspects, the one or more processors 1710 may be representative of the one or more processors 318 described with respect to FIG. 3. The one or more processors 1710 are coupled to a computer-readable medium/memory 1730 via a bus 1750. In certain aspects, the computer-readable medium/memory 1730 may be representative of the one or more memories 320 described with respect to FIG. 3. The computer-readable medium/memory 1730 is a non-transitory computer-readable medium/memory. In certain aspects, the computer-readable medium/memory 1730 is configured to store instructions (e.g., computer-executable code), that when executed by the one or more processors 1710, cause the one or more processors 1710 to perform the method 1200 described with respect to FIG. 12, or any aspect related to it, including any operations described in relation to FIG. 12; the method 1300 described with respect to FIG. 13, or any aspect related to it, including any operations described in relation to FIG. 13; the method 1400 described with respect to FIG. 14, or any aspect related to it, including any operations described in relation to FIG. 14; the method 1500 described with respect to FIG. 15, or any aspect related to it, including any operations described in relation to FIG. 15; and the method 1600 described with respect to FIG. 16, or any aspect related to it, including any operations described in relation to FIG. 16. Note that reference to a processor performing a function of communications device 1700 may include one or more processors performing that function of communications device 1700, such as in a distributed fashion.

In the depicted example, computer-readable medium/memory 1730 stores code (e.g., executable instructions), including code for sending 1735, code for obtaining 1740, and code for refraining 1745. Processing of the code 1735-1745 may enable and cause the communications device 1700 to perform the method 1200 described with respect to FIG. 12, or any aspect related to it; the method 1300 described with respect to FIG. 13, or any aspect related to it; the method 1400 described with respect to FIG. 14, or any aspect related to it; the method 1500 described with respect to FIG. 15, or any aspect related to it; and the method 1600 described with respect to FIG. 16, or any aspect related to it.

The one or more processors 1710 include circuitry configured to implement (e.g., execute) the code stored in the computer-readable medium/memory 1730, including circuitry for sending 1715, circuitry for obtaining 1720, and circuitry for refraining 1725. Processing with circuitry 1715-1725 may enable and cause the communications device 1700 to perform the method 1200 described with respect to FIG. 12, or any aspect related to it; the method 1300 described with respect to FIG. 13, or any aspect related to it; the method 1400 described with respect to FIG. 14, or any aspect related to it; the method 1500 described with respect to FIG. 15, or any aspect related to it; and the method 1600 described with respect to FIG. 16, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1755 and/or antenna 1760 of the communications device 1700 in FIG. 17, and/or one or more processors 1710 of the communications device 1700 in FIG. 17. Means for communicating, receiving or obtaining may include the one or more transceivers 324, one or more antennas 322, and/or processing system 316 of the UE 304 illustrated in FIG. 3, transceiver 1755 and/or antenna 1760 of the communications device 1700 in FIG. 17, and/or one or more processors 1710 of the communications device 1700 in FIG. 17. Means for refraining may include the processing system 316 of the UE 304 illustrated in FIG. 3, and/or one or more processors 1710 of the communications device 1700 in FIG. 17.

FIG. 18 depicts aspects of an example communications device 1800 configured for wireless communications. In certain aspects, communications device 1800 is a network entity, such as BS 102 of FIG. 1, first network entity 300 or second network entity of FIG. 3, or a disaggregated base station as discussed with respect to FIG. 2.

The communications device 1800 includes a processing system 1805 coupled to a transceiver 1845 (e.g., a transmitter and/or a receiver) and/or a network interface 1855. The transceiver 1845 is configured to transmit and receive signals for the communications device 1800 via an antenna 1850, such as the various signals as described herein. The network interface 1855 is configured to obtain and send signals for the communications device 1800 via communications link(s), such as a backhaul link, midhaul link, and/or fronthaul link as described herein, such as with respect to FIG. 2. The processing system 1805 may be configured to perform processing functions for the communications device 1800, including processing signals received and/or to be transmitted by the communications device 1800.

The processing system 1805 includes one or more processors 1810 and a computer-readable medium/memory 1825. In various aspects, the one or more processors 1810 may be representative of the one or more processors 308 described with respect to FIG. 3. The one or more processors 1810 are coupled to a computer-readable medium/memory 1825 via a bus 1840. In certain aspects, the computer-readable medium/memory 1825 may be representative of the one or more memories 310 described with respect to FIG. 3. The computer-readable medium/memory 1825 is a non-transitory computer-readable medium/memory. In certain aspects, the computer-readable medium/memory 1825 is configured to store instructions (e.g., computer-executable code), that when executed by the one or more processors 1810, cause the one or more processors 1810 to perform the method 1200 described with respect to FIG. 12, or any aspect related to it, including any operations described in relation to FIG. 12; the method 1300 described with respect to FIG. 13, or any aspect related to it, including any operations described in relation to FIG. 13; the method 1400 described with respect to FIG. 14, or any aspect related to it, including any operations described in relation to FIG. 14; and the method 1500 described with respect to FIG. 15, or any aspect related to it, including any operations described in relation to FIG. 15. Note that reference to a processor performing a function of communications device 1800 may include one or more processors performing that function of communications device 1800, such as in a distributed fashion.

In the depicted example, computer-readable medium/memory 1825 stores code (e.g., executable instructions), including code for sending 1830 and code for obtaining 1835. Processing of the code 1830 and 1835 may enable and cause the communications device 1800 to perform the method 1200 described with respect to FIG. 12, or any aspect related to it; the method 1300 described with respect to FIG. 13, or any aspect related to it; the method 1400 described with respect to FIG. 14, or any aspect related to it; and the method 1500 described with respect to FIG. 15, or any aspect related to it.

The one or more processors 1810 include circuitry configured to implement (e.g., execute) the code stored in the computer-readable medium/memory 1825, including circuitry for sending 1815 and circuitry for obtaining 1820. Processing with circuitry 1815 and 1820 may enable and cause the communications device 1800 to perform the method 1200 described with respect to FIG. 12, or any aspect related to it; the method 1300 described with respect to FIG. 13, or any aspect related to it; the method 1400 described with respect to FIG. 14, or any aspect related to it; and the method 1500 described with respect to FIG. 15, or any aspect related to it.

More generally, means for communicating, transmitting, sending or outputting for transmission may include the one or more transceivers 312, one or more antennas 314, and/or processing system 306 of the first network entity 300 and/or the second network entity 302 illustrated in FIG. 3, transceiver 1845, and/or antenna 1850, of the communications device 1800 in FIG. 18; and/or one or more processors 1810 of the communications device 1800 in FIG. 18. Means for communicating, receiving or obtaining may include the one or more transceivers 312, one or more antennas 314, and/or processing system 306 of the first network entity 300 and/or the second network entity 302 illustrated in FIG. 3, transceiver 1845, and/or antenna 1850, of the communications device 1800 in FIG. 18; and/or one or more processors 1810 of the communications device 1800 in FIG. 18.

### Example Clauses

Implementation examples are described in the following numbered clauses:

Clause 1: A method for wireless communications by a first device comprising: sending, to a first set of backscatter devices, one or more first signals via a first transmit beam at a first transmit power in one or more first transmission occasions; and sending, to a second set of backscatter devices, one or more second signals via a second transmit beam at a second transmit power in one or more second transmission occasions.

Clause 2: The method of Clause 1, wherein: the first set of backscatter devices includes a first backscatter device; the second set of backscatter devices includes a second backscatter device that is different from the first backscatter device; the first transmit beam is different from the second transmit beam; the first transmit power is different from the second transmit power; and the one or more first transmission occasions are non-overlapping in time with the one or more second transmission occasions.

Clause 3: The method of any one of Clauses 1-2, further comprising sending, to a third set of backscatter devices, one or more third signals via the first transmit beam at a third transmit power in one or more third transmission occasions.

Clause 4: The method of any one of Clauses 1-3, wherein: the first transmit power is based at least in part on a first path loss between the first set of backscatter devices and a second device; and the second transmit power is based at least in part on a second path loss between the second set of backscatter devices and the second device.

Clause 5: The method of any one of Clauses 1-4, wherein sending the one or more first signals comprises sending the one or more first signals via the first transmit beam and a third transmit beam.

Clause 6: The method of any one of Clauses 1-5, wherein: sending the one or more first signals comprises sending the one or more first signals in a first inventory procedure; and sending the one or more second signals comprises sending the one or more second signals in a second inventory procedure.

Clause 7: The method of any one of Clauses 1-6, wherein the one or more first signals includes one or more of a query message, a D2R link grant, an acknowledgement message, or a negative acknowledgement message.

Clause 8: The method of Clause 7, wherein the D2R link grant indicates a sequence associated with communication based at least in part on code division multiplexing.

Clause 9: The method of Clause 7 or 8, wherein the D2R link grant indicates one or more time-frequency resources associated with communication based at least in part on frequency division multiplexing.

Clause 10: The method of any one of Clauses 1-9, wherein: the first device includes a first network node; and the first set of backscatter devices includes an ambient IoT device.

Clause 11: A method for wireless communications by a first device comprising: obtaining, from a first set of backscatter devices, one or more first signals via a first receive beam within a first set of received signal powers in one or more first transmission occasions; and obtaining, from a second set of backscatter devices, one or more second signals via a second receive beam within a second set of received signal powers in one or more second transmission occasions.

Clause 12: The method of Clause 11, wherein: the first set of backscatter devices includes a first backscatter device; the second set of backscatter devices includes a second backscatter device that is different from the first backscatter device; the first receive beam is different from the second receive beam; the first set of received signal powers devices includes a first received signal power; the second set of received signal powers includes a second received signal power that is different from the first received signal power; and the one or more first transmission occasions are non-overlapping in time with the one or more second transmission occasions.

Clause 13: The method of any one of Clauses 11-12, further comprising obtaining an indication of a first schedule that indicates the one or more first transmission occasions and a second schedule that indicates the one or more second transmission occasions.

Clause 14: The method of any one of Clauses 11-13, further comprising obtaining, from a third set of backscatter devices, one or more third signals via the first receive beam within a third set of received signal powers in one or more third transmission occasions.

Clause 15: The method of any one of Clauses 11-14, wherein the first set of received signal powers is based at least in part on a path loss between the first set of backscatter devices and the first device.

Clause 16: The method of any one of Clauses 11-15, wherein obtaining the one or more first signals comprises obtaining the one or more first signals via the first receive beam and a third receive beam.

Clause 17: The method of any one of Clauses 11-16, wherein: obtaining the one or more first signals comprises obtaining the one or more first signals in a first inventory procedure; and obtaining the one or more second signals comprises obtaining the one or more second signals in a second inventory procedure.

Clause 18: The method of any one of Clauses 11-17, wherein the one or more first signals includes one or more of a response message, a device identifier, or device information.

Clause 19: The method of any one of Clauses 11-18, wherein obtaining the one or more first signals comprises obtaining the one or more first signals based at least in part on code division multiplexing.

Clause 20: The method of any one of Clauses 11-19, wherein obtaining the one or more first signals comprises obtaining the one or more first signals based at least in part on frequency division multiplexing.

Clause 21: The method of any one of Clauses 11-20, wherein: the first device includes a first network node; and the first set of backscatter devices includes an ambient IoT device.

Clause 22: A method for wireless communications by a first device comprising: sending, to a first set of backscatter devices, a first signal via a first beam at a first transmit power in one or more first transmission occasions; obtaining, from the first set of backscatter devices, a first set of signals via the first beam within a first set of received signal powers in one or more second transmission occasions; sending, to a second set of backscatter devices, a second signal via a second beam at a second transmit power in one or more third transmission occasions; and obtaining, from the second set of backscatter devices, a second set of signals via the second beam within a second set of received signal powers in one or more fourth transmission occasions.

Clause 23: The method of Clause 22, wherein: the first set of backscatter devices includes a first backscatter device; the second set of backscatter devices includes a second backscatter device that is different from the first backscatter device; the first beam is different from the second beam; the first transmit power is different from the second transmit power; the first set of received signal powers devices includes a first received signal power; the second set of received signal powers includes a second received signal power that is different from the first received signal power; and the one or more first transmission occasions are non-overlapping in time with the one or more second transmission occasions; the one or more second transmission occasions are non-overlapping in time with the one or more third transmission occasions; and the one or more third transmission occasions are non-overlapping in time with the one or more fourth transmission occasions.

Clause 24: The method of any one of Clauses 22-23, further comprising sending, to a second device, an indication of a schedule that indicates a set of transmit powers for communication of energy excitation signaling in at least the one or more second transmission occasions and the one or more fourth transmission occasions.

Clause 25: The method of Clause 24, wherein at least one transmit power of the set of transmit powers is based at least in part on a path loss between the first set of backscatter devices and the first device.

Clause 26: The method of any one of Clauses 22-25, further comprising: sending, to a third set of backscatter devices, a third signal via the first beam at a third transmit power in one or more fifth transmission occasions; and obtaining, from the third set of backscatter devices, a third set of signals via the first beam within a third set of received signal powers in one or more sixth transmission occasions.

Clause 27: The method of any one of Clauses 22-26, wherein the first transmit power is based on a path loss between the first set of backscatter devices and the first device.

Clause 28: The method of any one of Clauses 22-27, wherein sending the first signal comprises sending the first signal via the first beam and a third beam.

Clause 29: The method of any one of Clauses 22-28, wherein: sending the first signal comprises sending the first signal in a first inventory procedure; obtaining the first set of signals comprises obtaining the first set of signals in the first inventory procedure; sending the second signal comprises sending the second signal in a second inventory procedure; and obtaining the second set of signals comprises obtaining the second set of signals in the second inventory procedure.

Clause 30: The method of any one of Clauses 22-29, wherein: the first signal includes one or more of a query message, a D2R link grant, an acknowledgement message, or a negative acknowledgement message; and the first set of signals includes one or more of a response message, a device identifier, or device information.

Clause 31: The method of Clause 30, wherein the D2R link grant indicates a sequence associated with communication based at least in part on code division multiplexing.

Clause 32: The method of Clause 30 or 31, wherein the D2R link grant indicates one or more time-frequency resources associated with communication based at least in part on frequency division multiplexing.

Clause 33: The method of any one of Clauses 22-32, wherein: the first device includes a first network node; and the first set of backscatter devices includes an ambient IoT device.

Clause 34: A method for wireless communications by a first device comprising: sending, to a first set of backscatter devices, one or more first energy excitation signals at a first transmit power in one or more first transmission occasions; and sending, to a second set of backscatter devices, one or more second energy excitation signals at a second transmit power in one or more second transmission occasions.

Clause 35: The method of Clause 34, wherein: the first set of backscatter devices includes a first backscatter device; the second set of backscatter devices includes a second backscatter device that is different from the first backscatter device; the first transmit power is different from the second transmit power; and the one or more first transmission occasions are non-overlapping in time with the one or more second transmission occasions.

Clause 36: The method of any one of Clauses 34-35, wherein the one or more first energy excitation signals includes a continuous wave.

Clause 37: The method of any one of Clauses 34-36, further comprising obtaining, from a second device, an indication of a schedule that indicates a set of transmit powers for communication of energy excitation signaling in at least the one or more first transmission occasions and the one or more second transmission occasions.

Clause 38: The method of Clause 37, wherein at least one transmit power of the set of transmit powers is based on a path loss between a backscatter device and the second device.

Clause 39: The method of any one of Clauses 34-38, wherein the first transmit power is based on a path loss between a backscatter device and a second device.

Clause 40: The method of any one of Clauses 34-39, wherein: the one or more first transmission occasions are associated with a first inventory procedure; and the one or more second transmission occasions are associated with a second inventory procedure.

Clause 41: The method of any one of Clauses 34-40, wherein: the first device includes a radio frequency energy exciter; and the first set of backscatter devices includes an ambient IoT device.

Clause 42: A method for wireless communications by a backscatter device comprising: obtaining a first signal, associated with a first sector, in one or more first transmission occasions; sending a second signal in one or more second transmission occasions; obtaining an indication to ignore signaling associated with a second sector for a time period; obtaining a third signal associated with the second sector during the time period; and refraining from sending a reply associated with the third signal.

Clause 43: The method of Clause 42, wherein: the first sector is different from the second sector; and the one or more first transmission occasions are non-overlapping in time with the one or more second transmission occasions.

Clause 44: The method of any one of Clauses 42-43, wherein the indication to ignore signaling includes an acknowledgement message that indicates to ignore the signaling associated with the second sector.

Clause 45: The method of any one of Clauses 42-44, wherein the third signal includes a query message that includes the indication to ignore the signaling.

Clause 46: The method of any one of Clauses 42-45, wherein the first signal includes an indication of the first sector.

Clause 47: The method of any one of Clauses 42-46, further comprising obtaining an energy excitation signal from a radio frequency energy exciter, wherein sending the second signal comprises sending a backscatter of the energy excitation signal, wherein the backscatter includes the second signal.

Clause 48: The method of any one of Clauses 42-47, wherein: obtaining the first signal comprises obtaining the first signal from a first network node; and sending the second signal comprises sending the second signal to a second network node.

Clause 49: The method of any one of Clauses 42-48, wherein: obtaining the first signal comprises obtaining the first signal from a network node; and sending the second signal comprises sending the second signal to the network node.

Clause 50: The method of any one of Clauses 42-49, wherein: obtaining the first signal comprises obtaining the first signal in an inventory procedure; and sending the second signal comprises sending the second signal in the inventory procedure.

Clause 51: The method of any one of Clauses 42-50, wherein: the first signal includes one or more of a query message, a D2R link grant, an acknowledgement message, or a negative acknowledgement message; and the second signal includes one or more of a response message, a device identifier, or device information.

Clause 52: The method of any one of Clauses 42-51, wherein the backscatter device includes an ambient IoT device.

Clause 53: One or more apparatuses, comprising: one or more memories comprising executable instructions; and one or more processors configured to execute the executable instructions and cause the one or more apparatuses to perform a method in accordance with any one of Clauses 1-52.

Clause 54: One or more apparatuses configured for wireless communications, comprising: one or more memories; and one or more processors, coupled to the one or more memories, configured to cause the one or more apparatuses to perform a method in accordance with any one of Clauses 1-52.

Clause 55: One or more apparatuses configured for wireless communications, comprising: one or more memories; and one or more processors, coupled to the one or more memories, configured to perform a method in accordance with any one of Clauses 1-52.

Clause 56: One or more apparatuses, comprising means for performing a method in accordance with any one of Clauses 1-52.

Clause 57: One or more non-transitory computer-readable media comprising executable instructions that, when executed by one or more processors of one or more apparatuses, cause the one or more apparatuses to perform a method in accordance with any one of Clauses 1-52.

Clause 58: One or more computer program products embodied on one or more computer-readable storage media comprising code for performing a method in accordance with any one of Clauses 1-52.

Clause 59: One or more apparatuses configured for wireless communications, comprising: a processing system that includes one or more processors and one or more memories coupled with the one or more processors, the processing system configured to cause the one or more apparatuses to perform a method in accordance with any one of Clauses 1-52.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a first device to:
send, to a first set of backscatter devices, one or more first signals via a first transmit beam at a first transmit power in one or more first transmission occasions; and
send, to a second set of backscatter devices, one or more second signals via a second transmit beam at a second transmit power in one or more second transmission occasions.

2. The apparatus of claim 1, wherein:
the first set of backscatter devices includes a first backscatter device;
the second set of backscatter devices includes a second backscatter device that is different from the first backscatter device;
the first transmit beam is different from the second transmit beam;
the first transmit power is different from the second transmit power; and
the one or more first transmission occasions are non-overlapping in time with the one or more second transmission occasions.

3. The apparatus of claim 1, wherein the processing system is configured to cause the first device to send, to a third set of backscatter devices, one or more third signals via the first transmit beam at a third transmit power in one or more third transmission occasions.

4. The apparatus of claim 1, wherein:
the first transmit power is based at least in part on a first path loss between the first set of backscatter devices and a second device; and
the second transmit power is based at least in part on a second path loss between the second set of backscatter devices and the second device.

5. The apparatus of claim 1, wherein to cause the first device to send the one or more first signals, the processing system is configured to cause the first device to send the one or more first signals via the first transmit beam and a third transmit beam.

6. The apparatus of claim 1, wherein:
to cause the first device to send the one or more first signals, the processing system is configured to cause the first device to send the one or more first signals in a first inventory procedure; and
to cause the first device to send the one or more second signals, the processing system is configured to cause the first device to send the one or more second signals in a second inventory procedure.

7. The apparatus of claim 1, wherein the one or more first signals includes one or more of a query message, a device-to-reader (D2R) link grant, an acknowledgement message, or a negative acknowledgement message.

8. The apparatus of claim 7, wherein the D2R link grant indicates a sequence associated with communication based at least in part on code division multiplexing.

9. The apparatus of claim 7, wherein the D2R link grant indicates one or more time-frequency resources associated with communication based at least in part on frequency division multiplexing.

10. The apparatus of claim 1, wherein:
the first device includes a first network node; and
the first set of backscatter devices includes an ambient internet of things (IoT) device.

11. An apparatus for wireless communications, comprising a processing system that includes one or more processors and one or more memories coupled with the one or more processors, the processing system configured to cause a backscatter device to:
obtain a first signal, associated with a first sector, in one or more first transmission occasions;
send a second signal in one or more second transmission occasions;
obtain an indication to ignore signaling associated with a second sector for a time period;
obtain a third signal associated with the second sector during the time period; and
refrain from sending a reply associated with the third signal.

12. The apparatus of claim 11, wherein:
the first sector is different from the second sector; and
the one or more first transmission occasions are non-overlapping in time with the one or more second transmission occasions.

13. The apparatus of claim 11, wherein the indication to ignore signaling includes an acknowledgement message that indicates to ignore the signaling associated with the second sector.

14. The apparatus of claim 11, wherein the third signal includes a query message that includes the indication to ignore the signaling.

15. The apparatus of claim 11, wherein the first signal includes an indication of the first sector.

16. The apparatus of claim 11, wherein:
the processing system is configured to cause the backscatter device to obtain an energy excitation signal from a radio frequency energy exciter; and
to cause the backscatter device to send the second signal, the processing system is configured to cause the backscatter device to send a backscatter of the energy excitation signal, wherein the backscatter includes the second signal.

17. The apparatus of claim 11, wherein:
to cause the backscatter device to obtain the first signal, the processing system is configured to cause the backscatter device to obtain the first signal from a first network node; and
to cause the backscatter device to send the second signal, the processing system is configured to cause the backscatter device to send the second signal to a second network node.

18. The apparatus of claim 11, wherein:
to cause the backscatter device to obtain the first signal, the processing system is configured to cause the backscatter device to obtain the first signal from a network node; and
to cause the backscatter device to send the second signal, the processing system is configured to cause the backscatter device to send the second signal to the network node.

19. The apparatus of claim 11, wherein:
to cause the backscatter device to obtain the first signal, the processing system is configured to cause the backscatter device to obtain the first signal in an inventory procedure; and
to cause the backscatter device to send the second signal, the processing system is configured to cause the backscatter device to send the second signal in the inventory procedure.

20. A method for wireless communications by a first device, comprising:
sending, to a first set of backscatter devices, one or more first signals via a first transmit beam at a first transmit power in one or more first transmission occasions; and
sending, to a second set of backscatter devices, one or more second signals via a second transmit beam at a second transmit power in one or more second transmission occasions.
